(19) United States
(12) Patent Application Publication
(10) Pub. No.: US 2024/0397529 A1
(43) Pub. Date: Nov. 28, 2024

(54) INTER-UE COORDINATION INFORMATION

(71) Applicant: QUALCOMM Incorporated, San Diego, CA (US)

(72) Inventors: Tien Viet NGUYEN, Bridgewater, NJ (US); Gabi SARKIS, San Diego, CA (US); Sourjya DUTTA, San Diego, CA (US); Kapil GULATI, Belle Mead, NJ (US); Shuanshuan WU, San Diego, CA (US); Hui GUO, Beijing (CN)

(21) Appl. No.: 18/695,726

(22) PCT Filed: Sep. 13, 2022
(86) PCT No.: PCT/CN2022/118339

§ 371 Date: Mar. 26, 2024

(30) Foreign Application Priority Data
Nov. 5, 2021 (WO) PCT/CN2021/128889
Nov. 5, 2021 (WO) PCT/CN2021/128938

(51) Int. Cl. H04W 72/25; H04L 5/00

(52) U.S. Cl. CPC H04W 72/25; H04L 5/0094

(57) ABSTRACT

A UE determines an occurrence of a condition to trigger transmission of inter-UE coordination information based on a CR being below a threshold CR associated with a priority level for the inter-UE coordination information and transmits a sidelink message that includes the inter-UE coordination information in response to the occurrence of the condition for the inter-UE coordination information.

### CROSS REFERENCE TO RELATED APPLICATION(S)

This application claims the benefit of and priority to International Application Serial No. PCT/CN2021/128938, entitled “Inter-UE Coordination Information” and filed on Nov. 5, 2021, and International Application Serial No. PCT/CN2021/128889, entitled “Inter User Equipment Coordination” and filed on Nov. 5, 2021, the contents of each of which are expressly incorporated by reference herein in its entirety.

### BACKGROUND

### Technical Field

The present disclosure relates generally to communication systems, and more particularly, to sidelink communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. Some aspects of wireless communication may comprise direct communication between devices based on sidelink. There exists a need for further improvements in sidelink technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication. The apparatus determines an occurrence of a condition to trigger transmission of inter-UE coordination information based on a channel occupancy ratio (CR) being below a threshold CR associated with a priority level for the inter-UE coordination information and transmits a sidelink message that includes the inter-UE coordination information in response to the occurrence of the condition for the inter-UE coordination information.

In an aspect of the disclosure, a method, a computer-readable medium, and an apparatus are provided for wireless communication. The apparatus receives an indication enabling one or more types of inter-UE coordination information to be included in inter-UE coordination information; and transmits a sidelink message that includes the one or more types of inter-UE coordination information enabled by the indication.

In an aspect of the disclosure, a method, a computer-readable medium, and an apparatus are provided for wireless communication. The apparatus receives an indication enabling a trigger for inter-UE coordination information; and transmits a sidelink message that includes the inter-UE coordination information in response to an occurrence of the trigger that is enabled for the inter-UE coordination information.

In an aspect of the disclosure, a method, a computer-readable medium, and an apparatus are provided for wireless communication. The apparatus transmits, to a user equipment (UE), a configuration for inter-UE coordination information. The apparatus provides an indication enabling one or more types of inter-UE coordination information to be included in an inter-UE coordination information transmission.

In an aspect of the disclosure, a method, a computer-readable medium, and an apparatus are provided for wireless communication. The apparatus transmits, to a UE, a configuration for inter-UE coordination information. The apparatus provides an indication enabling a condition to trigger a transmission of inter-UE coordination information.

In an aspect of the disclosure, a method, a computer-readable medium, and an apparatus are provided for wireless communication. The apparatus receives a resource reservation for one or more resources in a resource pool configured for sidelink communication. The apparatus transmits an indication of the resource reservation using an entry-based format or a bitmap-based format, wherein the entry-based format or the bitmap-based format is selected based at least in part on a configuration of the resource pool, a periodicity of the resource reservation, a size of the resource reservation, or whether the indication of the resource reservation is multiplexed with sidelink data.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network, in accordance with aspects of the present disclosure.

FIG. 2 illustrates example aspects of a sidelink slot structure, in accordance with aspects of the present disclosure.

FIG. 3 is a diagram illustrating an example of a first device and a second device involved in wireless communication based, e.g., on sidelink, in accordance with aspects of the present disclosure.

FIG. 4 illustrates example aspects of sidelink communication between devices, in accordance with aspects presented herein, in accordance with aspects of the present disclosure.

FIGS. 5A and 5B illustrate examples of resource reservation for sidelink communication, in accordance with aspects of the present disclosure.

FIG. 6 is an example time diagram for sidelink resource selection, in accordance with aspects of the present disclosure.

FIG. 7 illustrates an example of inter-UE coordination for sidelink communication, in accordance with aspects of the present disclosure.

FIG. 8 is a diagram illustrating an example of coordination signaling using an entry-based format or a bitmap-based format, in accordance with aspects of the present disclosure.

FIG. 9 is a diagram illustrating an example associated with inter user equipment coordination, in accordance with the present disclosure.

FIG. 10A and FIG. 10B are communication flows between UEs that includes the exchange of inter-UE coordination information, in accordance with aspects of the present disclosure.

FIG. 11A and FIG. 11B are communication flows between UEs that includes the exchange of inter-UE coordination information, in accordance with aspects of the present disclosure.

FIG. 12 is a diagram illustrating an example process associated with inter user equipment coordination, in accordance with aspects of the present disclosure.

FIG. 13 is a diagram of an example apparatus for wireless communication, in accordance with aspects of the present disclosure.

FIG. 14A and FIG. 14B are flowcharts of methods of wireless communication including the transmission of inter-UE coordination information, in accordance with aspects of the present disclosure.

FIG. 15A and FIG. 15B are flowcharts of methods of wireless communication including the transmission of inter-UE coordination information, in accordance with aspects of the present disclosure.

FIG. 16 is a diagram illustrating an example of a hardware implementation for an example apparatus, in accordance with aspects of the present disclosure.

FIG. 17A and FIG. 17B are flowcharts of methods of wireless communication including the enablement of one or more types of inter-UE coordination information, in accordance with aspects of the present disclosure.

FIG. 18A and FIG. 18B are flowcharts of methods of wireless communication including the configuration of one or more conditions for inter-UE coordination information, in accordance with aspects of the present disclosure.

FIG. 19 is a diagram illustrating an example of a hardware implementation for an example apparatus, in accordance with aspects of the present disclosure.

### DETAILED DESCRIPTION

A UE may perform autonomous resource selection for sidelink transmission, which may be referred to as resource allocation mode 2 for sidelink communication. The UE may receive various types of information that may be used for sidelink resource selection. For example, the UE may perform sensing to receive sidelink resource reservations of other UEs. As another example, the UE may receive sidelink reservation information from one or more other UEs. The sidelink reservation information may include a reservation of resources from the other UEs or may include inter-UE coordination information. Inter-UE coordination information may indicate at least one of preferred resources for sidelink transmission by the UE, non-preferred resources for sidelink transmission by the UE, or resource conflict information. The UE may include inter-UE coordination information based on the reservation information/inter-UE coordination information received from other UEs when transmitting its own resource reservation.

Aspects presented herein enable control of a size and content of inter-UE coordination information. The UE may receive an indication that enables one or more potential types of inter-UE coordination information. Aspects presented herein provide for control of conditions that may trigger the inter-UE coordination information through an indication to the UE that enables one or more conditions for the transmission of the inter-UE coordination information.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

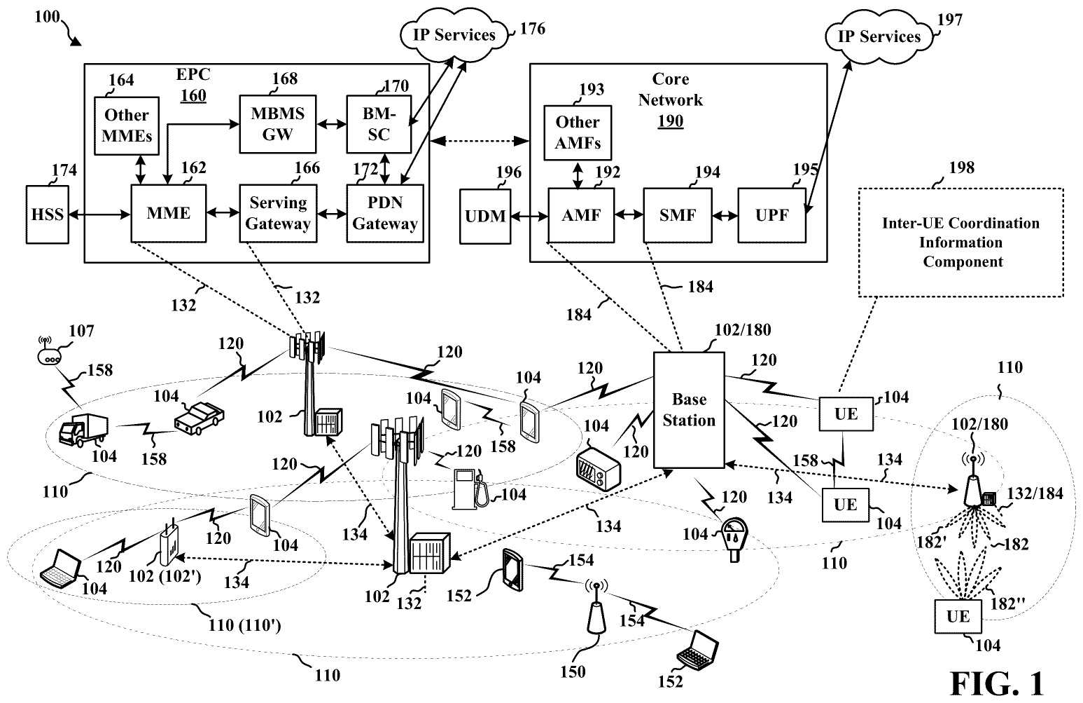

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells. A link between a UE 104 and a base station 102 or 180 may be established as an access link, e.g., using a Uu interface. Other communication may be exchanged between wireless devices based on sidelink. For example, some UEs 104 may communicate with each other directly using a device-to-device (D2D) communication link 158. In some examples, the D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

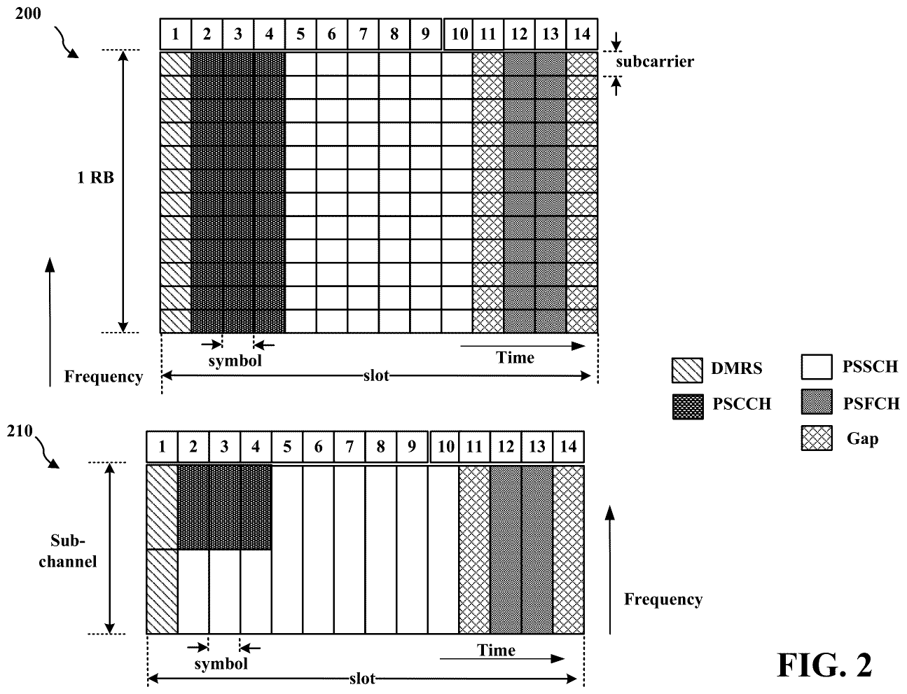

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSe), etc. In addition to UEs, sidelink communication may also be transmitted and received by other transmitting and receiving devices, such as Road Side Unit (RSU) 107, etc. Sidelink communication may be exchanged using a PC5 interface, such as described in connection with the example in FIG. 2. Although the following description, including the example slot structure of FIG. 2, may provide examples for sidelink communication in connection with 5G NR, the concepts described herein may be applicable to other similar areas, such as LTE, LTE-A, CDMA, GSM, and other wireless technologies.

In FIG. 1, a UE may receive inter-UE coordination information from another UE. The UE 104 may include an inter-UE coordination information component 198 configured to receive an indication enabling one or more types of inter-UE coordination information to be included in inter-UE coordination information and to transmit a sidelink message that includes the one or more types of inter-UE coordination information enabled by the indication. In some aspects, the inter-UE coordination information component 198 may be configured to receive an indication enabling a trigger for inter-UE coordination information and to transmit a sidelink message that includes the inter-UE coordination information in response to an occurrence of the trigger that is enabled for the inter-UE coordination information.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHZ-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming. Similarly, beamforming may be applied for sidelink communication, e.g., between UEs.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same. Although this example is described for the base station 180 and UE 104, the aspects may be similarly applied between a first and second device (e.g., a first and second UE) for sidelink communication.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

FIG. 2 includes diagrams 200 and 210 illustrating example aspects of slot structures that may be used for sidelink communication (e.g., between UEs 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 2 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 200 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may comprise 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 210 in FIG. 2 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2, some of the REs may include control information in PSCCH and some REs may include demodulation RS (DMRS). At least one symbol may be used for feedback. FIG. 2 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may comprise the data message described herein. The position of any of the data, DMRS, SCI, feedback, gap symbols, and/or LBT symbols may be different than the example illustrated in FIG. 2. Multiple slots may be aggregated together in some aspects.

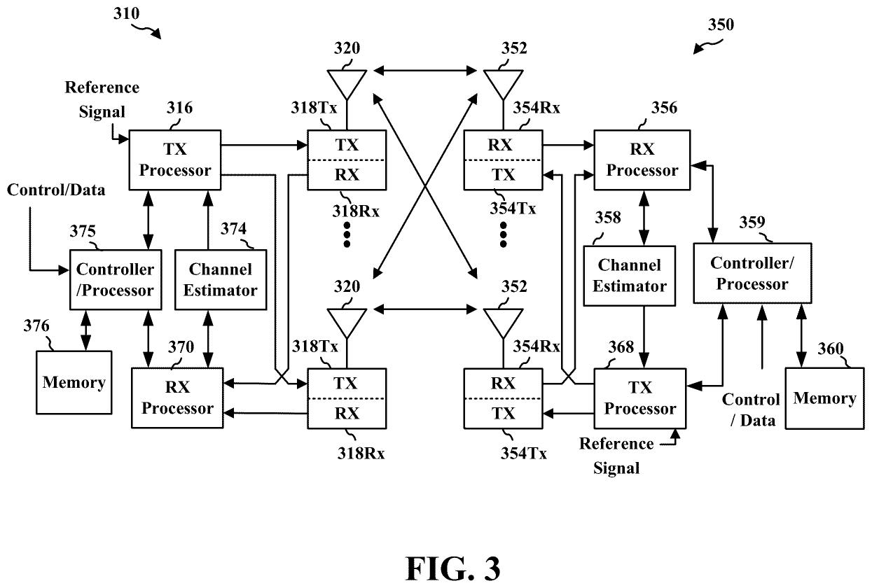

FIG. 3 is a block diagram of a first wireless communication device 310 in communication with a second wireless communication device 350 based on sidelink. In some examples, the devices 310 and 350 may communicate based on V2X or other D2D communication. The communication may be based on sidelink using a PC5 interface. The devices 310 and the 350 may comprise a UE, an RSU, a base station, etc. Packets may be provided to a controller/processor 375 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the device 350. Each spatial stream may then be provided to a different antenna 320 via a separate transmitter 318Tx. Each transmitter 318Tx may modulate an RF carrier with a respective spatial stream for transmission.

At the device 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the device 350. If multiple spatial streams are destined for the device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by device 310. These soft decisions may be based on channel estimates computed by the channel estimator 358. The soft decisions are then decoded and deinterleaved to recover the data and control signals that were originally transmitted by device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. The controller/processor 359 may provide demultiplexing between transport and logical channels, packet reassembly, deciphering, header decompression, and control signal processing. The controller/processor 359 is also responsible for error detection using an ACK and/or NACK protocol to support HARQ operations.

Similar to the functionality described in connection with the transmission by device 310, the controller/processor 359 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by device 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The transmission is processed at the device 310 in a manner similar to that described in connection with the receiver function at the device 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. The controller/processor 375 provides demultiplexing between transport and logical channels, packet reassembly, deciphering, header decompression, control signal processing. The controller/processor 375 is also responsible for error detection using an ACK and/or NACK protocol to support HARQ operations.

At least one of the TX processor 368/316, the RX processor 356/370, and the controller/processor 359/375 may be configured to perform aspects in connection with the inter-UE coordination information component 198 of FIG. 1.

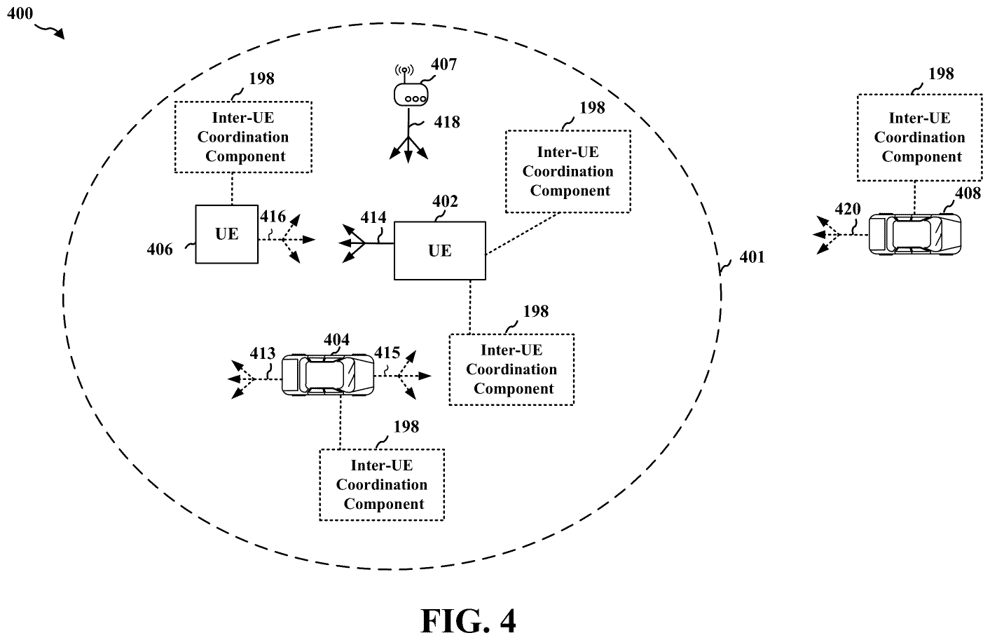

FIG. 4 illustrates an example 400 of sidelink communication between devices. The communication may be based on a slot structure comprising aspects described in connection with FIG. 2. For example, the UE 402 may transmit a sidelink transmission 414, e.g., comprising a control channel (e.g., PSCCH) and/or a corresponding data channel (e.g., PSSCH), that may be received by UEs 404, 406, 408. A control channel may include information (e.g., sidelink control information (SCI)) for decoding the data channel including reservation information, such as information about time and/or frequency resources that are reserved for the data channel transmission. For example, the SCI may indicate a number of TTIs, as well as the RBs that will be occupied by the data transmission. The SCI may also be used by receiving devices to avoid interference by refraining from transmitting on the reserved resources. The UEs 402, 404, 406, 408 may each be capable of sidelink transmission in addition to sidelink reception. Thus, UEs 404, 406, 408 are illustrated as transmitting sidelink transmissions 413, 415, 416, 420. The sidelink transmissions 413, 414, 415, 416, 420 may be unicast, broadcast or multicast to nearby devices. For example, UE 404 may transmit communication (e.g., 413, 415) intended for receipt by other UEs within a range 401 of UE 404, and UE 406 may transmit communication (e.g., 416). Additionally, or alternatively, RSU 407 may receive communication from and/or transmit communication 418 to UEs 402, 404, 406, 408. One or more of the UEs 402, 404, 406, 408 or the RSU 407 may comprise an inter-UE coordination information component 198.

Sidelink communication may be based on different types or modes of resource allocation mechanisms. In a first resource allocation mode (which may be referred to herein as “Mode 1”), centralized resource allocation may be provided by a network entity. For example, a base station 102 or 180 may determine resources for sidelink communication and may allocate resources to different UEs 104 to use for sidelink transmissions. In this first mode, a UE receives the allocation of sidelink resources from the base station 102 or 180. In a second resource allocation mode (which may be referred to herein as “Mode 2”), distributed resource allocation may be provided. In Mode 2, each UE may autonomously determine resources to use for sidelink transmission. In order to coordinate the selection of sidelink resources by individual UEs, each UE may use a sensing technique to monitor for resource reservations by other sidelink UEs and may select resources for sidelink transmissions from unreserved resources. Devices communicating based on sidelink, may determine one or more radio resources in the time and frequency domain that are used by other devices in order to select transmission resources that avoid collisions with other devices. The sidelink transmission and/or the resource reservation may be periodic or aperiodic, where a UE may reserve resources for transmission in a current slot and up to two future slots (discussed below).

Thus, in the second mode (e.g., Mode 2), individual UEs may autonomously select resources for sidelink transmission, e.g., without a central entity such as a base station indicating the resources for the device. A first UE may reserve the selected resources in order to inform other UEs about the resources that the first UE intends to use for sidelink transmission(s).

In some examples, the resource selection for sidelink communication may be based on a sensing-based mechanism. For instance, before selecting a resource for a data transmission, a UE may first determine whether resources have been reserved by other UEs.

For example, as part of a sensing mechanism for resource allocation mode 2, the UE may determine (e.g., sense) whether the selected sidelink resource has been reserved by other UE(s) before selecting a sidelink resource for a data transmission. If the UE determines that the sidelink resource has not been reserved by other UEs, the UE may use the selected sidelink resource for transmitting the data, e.g., in a PSSCH transmission. The UE may estimate or determine which radio resources (e.g., sidelink resources) may be in-use and/or reserved by others by detecting and decoding sidelink control information (SCI) transmitted by other UEs. The UE may use a sensing-based resource selection algorithm to estimate or determine which radio resources are in-use and/or reserved by others. The UE may receive SCI from another UE that includes reservation information based on a resource reservation field comprised in the SCI. The UE may continuously monitor for (e.g., sense) and decode SCI from peer UEs. The SCI may include reservation information, e.g., indicating slots and RBs that a particular UE has selected for a future transmission. The UE may exclude resources that are used and/or reserved by other UEs from a set of candidate resources for sidelink transmission by the UE, and the UE may select/reserve resources for a sidelink transmission from the resources that are unused and therefore form the set of candidate resources. The UE may continuously perform sensing for SCI with resource reservations in order to maintain a set of candidate resources from which the UE may select one or more resources for a sidelink transmission. Once the UE selects a candidate resource, the UE may transmit SCI indicating its own reservation of the resource for a sidelink transmission. The number of resources (e.g., sub-channels per subframe) reserved by the UE may depend on the size of data to be transmitted by the UE. Although the example is described for a UE receiving reservations from another UE, the reservations may also be received from an RSU or other device communicating based on sidelink.

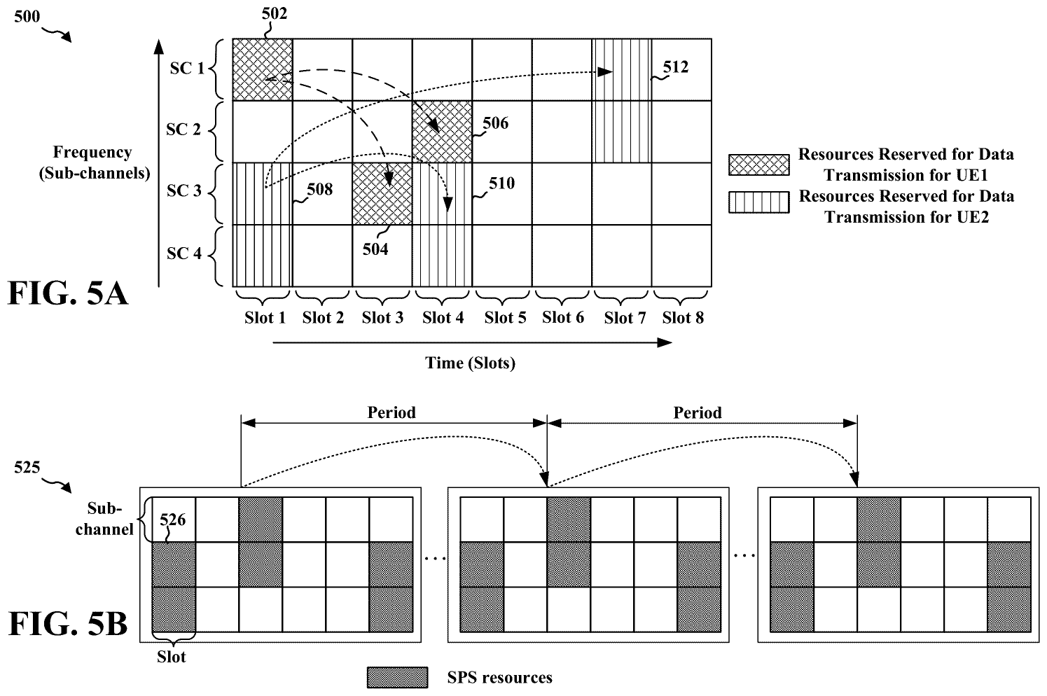

Sidelink resource reservations may be periodic or aperiodic. FIG. 5A illustrates an example 500 of time and frequency resources showing aperiodic reservations for sidelink transmissions. FIG. 5B illustrates an example 525 of periodic reservations for sidelink transmissions. The resources may be comprised in a sidelink resource pool, for example. The resource allocation for each UE may be in units of one or more sub-channels in the frequency domain (e.g., sub-channels SCI to SC 4), and may be based on one slot in the time domain. The UE may also use resources in the current slot to perform an initial transmission, and may reserve resources in future slots for retransmissions. In this example, two different future slots are being reserved by UE1 and UE2 for retransmissions. The resource reservation may be limited to a window of time or slots. The initial candidate set of potential resources for a sidelink transmission may include 8 slots by 4 sub-channels, which provides 32 available resource blocks in total. This window may also be referred to as a resource selection window.

A first UE (“UE1) may reserve a sub-channel (e.g., SC 1) in a current slot (e.g., slot 1) for its initial data transmission 502, and may reserve additional future slots within the window for data retransmissions (e.g., 504 and 506). For example, UE1 may reserve sub-channels SC 3 at slots 3 and SC 2 at slot 4 for future retransmissions as shown by FIG. 4. UE1 then transmits information regarding which resources are being used and/or reserved by it to other UE(s). UE1 may do by including the reservation information in the reservation resource field of the SCI, e.g., a first stage SCI.

FIG. 5A illustrates that a second UE (“UE2”) reserves resources in sub-channels SC 3 and SC 4 at time slot 1 for its current data transmission 508, and reserve first data retransmission 510 at time slot 4 using sub-channels SC 3 and SC 4, and reserve second data retransmission 512 at time slot 7 using sub-channels SC 1 and SC 2 as shown by FIG. 5A. Similarly, UE2 may transmit the resource usage and reservation information to other UE(s), such as using the reservation resource field in SCI.

A third UE may consider resources reserved by other UEs within the resource selection window to select resources to transmit its data. The third UE may first decode SCIs within a time period to identify which resources are available (e.g., candidate resources). For example, the third UE may exclude the resources reserved by UE1 and UE2 and may select other available sub-channels and time slots from the candidate resources for its transmission and retransmissions, which may be based on a number of adjacent sub-channels in which the data (e.g., packet) to be transmitted can fit.

While FIG. 5A illustrates resources being reserved for an initial transmission and two retransmissions, the reservation may be for an initial transmission and a single transmission or only for an initial transmission.

FIG. 5B illustrates an example 525 of a periodic resource reservation. Periodic resource reservation and signaling may be disabled by configuration. A period, with configurable values, may be signaled in SCI. As an example, a period may have a value between 0 ms and 1000 ms. Sidelink resources may be reserved periodically, such as for SPS resources. In SPS, initial transmissions of a subsequent period in an SPS flow may be protected by an earlier SPS transmission. FIG. 5B illustrates an initial transmission may indication a resource reservation, e.g., at 526, for the SPS resources. Then, the reservation of the SPS resources in subsequent periods may be indicated by a prior SPS transmission. Transmitting a self-reservation for the initial SPS transmission of SPS traffic in subsequent periods may be redundant to the reservation indication by the prior SPS transmission.

The UE may determine an associated signal measurement (such as RSRP) for each resource reservation received by another UE. The UE may consider resources reserved in a transmission for which the UE measures an RSRP below a threshold to be available for use by the UE. A UE may perform signal/channel measurement for a sidelink resource that has been reserved and/or used by other UE(s), such as by measuring the RSRP of the message (e.g., the SCI) that reserves the sidelink resource. Based at least in part on the signal/channel measurement, the UE may consider using/reusing the sidelink resource that has been reserved by other UE(s). For example, the UE may exclude the reserved resources from a candidate resource set if the measured RSRP meets or exceeds the threshold, and the UE may consider a reserved resource to be available if the measured RSRP for the message reserving the resource is below the threshold. The UE may include the resources in the candidate resources set and may use/reuse such reserved resources when the message reserving the resources has an RSRP below the threshold, because the low RSRP indicates that the other UE is potentially distant and a reuse of the resources is less likely to cause interference to that UE. A higher RSRP indicates that the transmitting UE that reserved the resources is potentially closer to the UE and may experience higher levels of interference if the UE selected the same resources.

For example, in a first step, the UE may determine a set of candidate resources (e.g., by monitoring SCI from other UEs and removing resources from the set of candidate resources that are reserved by other UEs in a signal for which the UE measures an RSRP above a threshold value). In a second step, the UE may select N resources for transmissions and/or retransmissions of a TB. As an example, the UE may randomly select the N resources from the set of candidate resources determined in the first step. In a third step, for each transmission, the UE may reserve future time and frequency resources for an initial transmission and up to two retransmissions. The UE may reserve the resources by transmitting SCI indicating the resource reservation. For example, in the example in FIG. 5A, the UE may transmit SCI reserving resources for data transmissions (e.g., 508, 510, and 512).

There may be a timeline for a sensing-based resource selection. For example, the UE may sense and decode the SCI received from other UEs during a sensing window, e.g., a time duration prior to resource selection. Based on the sensing history during the sensing window, the UE may be able to maintain a set of available candidate resources by excluding resources that are reserved by other UEs from the set of candidate resources. A UE may select resources from its set of available candidate resources and transmits SCI reserving the selected resources for sidelink transmission (e.g., a PSSCH transmission) by the UE. There may be a time gap between the UE's selection of the resources and the UE transmitting SCI reserving the resources.

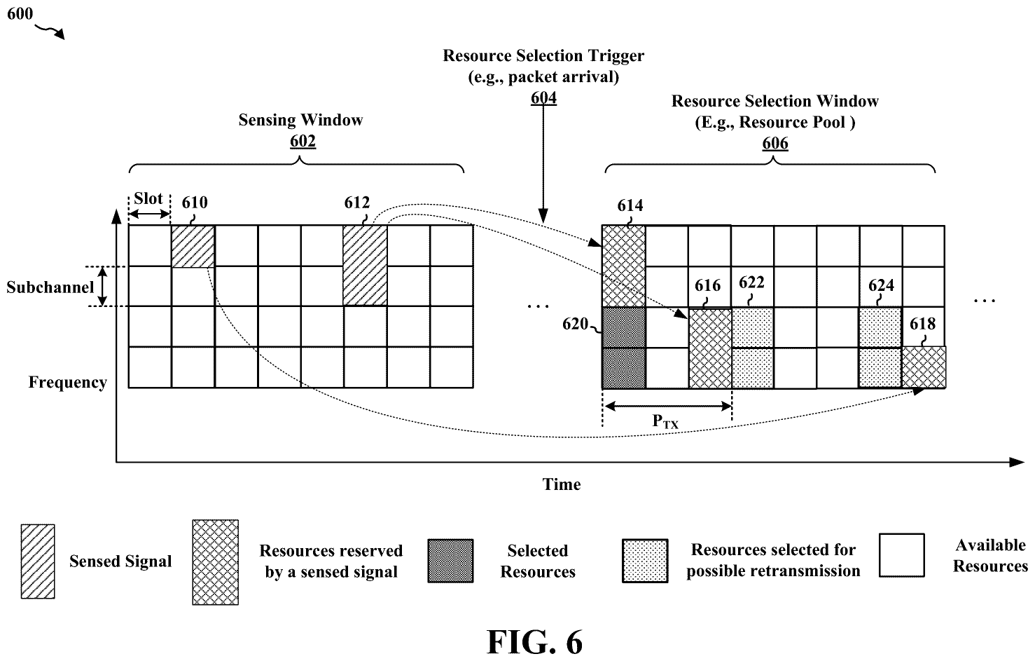

FIG. 6 illustrates an example timeline 600 for sidelink resource selection based on sensing. In FIG. 6, the UE may receive sidelink transmission 610 and sidelink transmission 612 during the sensing window 602. FIG. 6 illustrates an example sensing window including 8 consecutive time slots and 4 consecutive sub-channels, which spans 32 resource blocks. The sidelink transmission 610 indicates a resource reservation for resource 618, and sidelink transmission 612 indicates a resource reservation for resources 614 and 622. For example, the sidelink transmissions 610 and 612 may each include SCI that indicates the corresponding resource reservation. Resource reservations may be periodic or aperiodic. Different reservations of resources may have different priority levels, e.g., with the priority level indicated in the SCI.

A UE receiving the transmissions 610 and 612 may exclude the resources 614, 616, and 618 as candidate resources in a candidate resource set based on the resource selection window 606. In some examples, the sidelink device may exclude the resources 614, 616, or 618 based on whether a measured RSRP for the received SCI (e.g., in 610 or 612) meets a threshold. When a resource selection trigger occurs at 604, such as the sidelink device having a packet for sidelink transmission, the sidelink device may select resources for the sidelink transmission (e.g., including PSCCH and/or PSSCH) from the remaining resources of the resource pool within the resource selection window 606 after the exclusion of the reserved resources (e.g., 614, 616, and 618). FIG. 6 illustrates an example in which the sidelink device selects the resource 620 for sidelink transmission. The sidelink device may also select resources 622 and/or 624 for a possible retransmission. After selecting the resources for transmission, the sidelink device may transmit SCI indicating a reservation of the selected resources. Thus, each sidelink device may use the sensing/reservation procedure to select resources for sidelink transmissions from the available candidate resources that have not been reserved by other sidelink devices

In some instances, multiple UEs may transmit at the same time and may not receive the overlapping communication (e.g., SCI indicating resource reservations) from each other and/or from a base station. Such a UE may miss or be unaware of transmissions and sidelink reservations by other UEs. Therefore, two UEs may reserve the same resource block for a future sidelink transmission, which may result in a resource collision. A resource collision occurs for sidelink transmissions that overlap at least partially in time, and which may overlap, at least partially, in frequency.

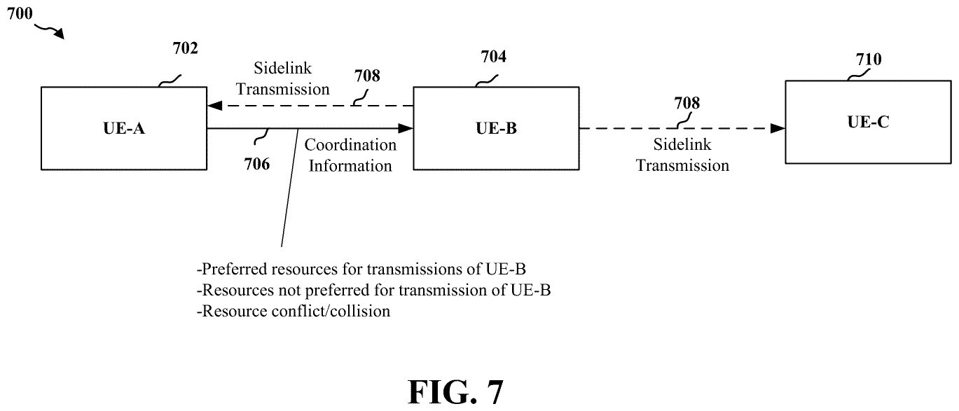

To reduce or avoid resource collisions under such instances, and to improve sidelink communication among UEs, the UEs may coordinate among themselves by generating and sharing inter-UE coordination information signaling with other UEs. FIG. 7 is a diagram 700 illustrating the exchange of inter-UE coordination information, where a first UE (“UE-A” 702) transmits inter-UE coordination information 706, e.g., in a coordination message over sidelink, to a second UE (“UE-B”) 704. In some aspects, the transmission of inter-UE coordination information may include resource reservation forwarding by the UE-A.

The inter-UE coordination information 706 may include information based on the UE's sensing information (e.g., resource reservations of other UEs that are sensed by UE-A 702), inter-UE coordination information from another UE, resources that are bad, undesirable, or non-preferred for the UE-A 702 (e.g., resources subject to high interference), resources which are preferred or better than other resources for the UE-A 702, etc. The UE-A 702 may determine a set of sidelink resources available for a resource allocation. The UE-A 702 may determine the set of sidelink resources based at least in part on determining that the set of sidelink resources are to be selected or based at least in part on a request, referred to herein as an inter-UE coordination request, received from the UE-B 704 or a base station. The UE-A 702 and the UE-B 704 may operate in an in-coverage mode, a partial coverage mode, or an out-of-coverage mode with a base station, for example. In some aspects, the UE-A 702 may determine the set of sidelink resources based at least in part on a sensing operation, which may be performed before receiving an inter-UE coordination request or after receiving the inter-UE coordination request. In some aspects, the UE-A 702 may determine the set of sidelink resources based at least in part on a satisfaction of one or more conditions.

The inter-UE coordination information 706 may indicate candidate resources for sidelink transmission or preferred resources for transmissions by UE-B 704. The UE-A 702 may use the inter-UE coordination information 706 to inform the UE-B 704 about which sub-channels and slots may be used for communicating with the UE-A 702 and/or which sub-channels and slots may not be used because they are occupied or reserved by the UE-A 702 and/or other UEs. The UE-A may indicate a set of resources that may be more suitable for UE-B's transmission based on UE-A's evaluation. The candidate resources may indicate a group of resources from which the UE-B 704 (e.g., UE-B) may select for the sidelink transmission 708. As illustrated, the sidelink transmission 708 may be for UE-A 702 or for one or more different UEs, e.g., UE-C 710. In some aspects, the UE-A may be a potential receiver of the UE-B's transmission, and the inter-UE coordination information may enable mode 2 resource allocation that is based on resource availability from a potential receiver's perspective, which may address reception challenges for a hidden node. In some aspects, the inter-UE coordination information 706 may indicate resources for a sidelink transmission, e.g., particular resources on which the UE-B 704 is to transmit the sidelink transmission 708 rather than candidate resources that the UE-B 704 may select.

The UE-A 702 may transmit an indication of the set of available resources to the UE-B 704 via inter-UE coordination signaling (shown as a coordination message, and referred to in some aspects as an inter-UE coordination message or inter-UE coordination information). In some aspects, the UE-A 702 may transmit the indication of the set of available resources while operating in NR sidelink resource allocation mode 2. In NR sidelink resource allocation mode 2, resource allocation is handled by UEs (e.g., in comparison to NR sidelink resource allocation mode 1, in which resource allocation is handled by a scheduling entity, such as a base station). In some aspects, the set of available resources may be included in a resource pool. The resource pool may include a plurality of resources that may be used by the UEs (e.g., the UE-A 702 and the UE-B 704) for respective transmissions and receptions. For example, the resource pool may include a set of time and frequency resources that are reserved to be used for inter-UE communications (e.g., sidelink communications).

In some aspects, the indication of the set of available resources may identify resources that are preferred by the UE-A 702 for transmissions by the UE-B 704. In some aspects, the inter-UE coordination information 706 may indicate a set of resources that may not be preferred for UE-B's transmission, such as resources that may not be available for UE-B to transmit a sidelink transmission based on the UE-A's evaluation.

In some aspects, the inter-UE coordination information 706 may indicate a half-duplex conflict. For example, the inter-UE coordination information 706 may indicate a collision in time and/or frequency for two transmitting UEs that are unable to receive the other, respective transmission in a half-duplex mode. In some aspects, the inter-UE coordination information 706 may indicate a collision of resources (e.g., reserved resources) in time and/or frequency. The inter-UE coordination signaling may indicate a resource conflict (e.g., a collision), such as when two UEs have reserved the same resource (e.g., and were unable to detect this conflict because the two UEs transmitted a resource reservation message on the same resource and thus did not receive one another's resource reservation messages due to a half-duplex constraint).

Based at least in part on the inter-UE coordination information 706 from the UE-A 702, the UE-B 704 may make a better decision on which resources to use and/or reserve for its sidelink transmission 708 to avoid resource collisions. The UE-B 704 may select a sidelink resource for a transmission from the UE-B 704 based at least in part on the set of resources being available or not available indicated by the UE-A 702. As shown, the UE-B 704 may account for the coordination information when transmitting (e.g., via a sidelink resource indicated as available or not available by the inter-UE coordination message). Inter-UE coordination signaling related to resource allocation may increase a packet reception rate at the UE-A 702, and may reduce a power consumption for the UE-A 702 and/or the UE-B 704 (e.g., due to fewer retransmissions as a result of fewer collisions).

The UE-A 702 may share its inter-UE coordination information 706 with multiple UEs, and the UE-B 704 may receive the inter-UE coordination information 706 from multiple UEs. Inter-UE coordination information 706 may be transmitted in any of various ways. For example, although FIG. 3 shows a single UE-A 702 transmitting inter-UE coordination information to a single UE-B 704, in some aspects, a single UE-A 702 may transmit inter-UE coordination information to multiple UEs to assist those UEs with selecting resources for transmissions. Additionally, or alternatively, the UE-B 704 may receive inter-UE coordination information from multiple UEs, and may use that information to select resources for a transmission (e.g., resources that avoid a conflict with all of the multiple UEs or as many as possible).

The UE-A 702 may transmit inter-UE coordination information 706 in a PSFCH, e.g., indicating a resource collision or a half-duplex conflict indication. The UE-A 702 may transmit inter-UE coordination information 706 in SCI. For example, the UE-A 702 may transmit shared sensing information, candidate resource information for a sidelink transmission, or particular resources for a sidelink transmission in SCI-2 transmitted in PSSCH. For example, a first portion of SCI (e.g., SCI-1) may be transmitted in PSCCH, and a second portion of SCI (e.g., SCI-2) may be transmitted in PSSCH. The UE-A 702 may transmit inter-UE coordination information 706 in a MAC-CE, e.g., on the PSSCH. The UE-A 702 may transmit the inter-UE coordination information 706 in a new physical channel (e.g., that is different than PSCCH, PSSCH, PSFCH, etc.). For example, the UE-A 702 may transmit the inter-UE coordination information 706 in a physical channel that is configured for or dedicated to inter-UE configuration information. The UE-A 702 may transmit the inter-UE coordination information 706 in RRC signaling.

In some aspects, an indication of the resource reservation may be transmitted using an entry-based format or a bitmap-based format. The UE-A 702 may be configured to determine whether to transmit the indication of the resource reservation using the entry-based format, or the bitmap-based format, based at least in part on a number of conditions, such as a configuration of the resource pool, a periodicity of the resource reservation, a size of the resource reservation, or whether the resource reservation is multiplexed with other data, as described further herein.

In some aspects, the UE-A 702 may transmit the inter-UE coordination information 706 periodically. In some aspects, the UE-A 702 may transmit aperiodic inter-UE coordination information 706 in response to a trigger. Among other examples, the trigger may be based on the occurrence of an event, such as the occurrence of/detection of a resource collision, the occurrence of/detection of a half-duplex conflict, etc. For example, if the UE-A 702 detects a resource collision, the UE-A 702 may respond by transmitting inter-UE coordination information 706.

In a first scheme, the coordination information 706 sent from UE-A 702 to UE-B 704 is the set of resources preferred and/or non-preferred for UE-B's transmission 708. In some aspects. In some aspects, the inter-UE coordination information 706 may include additional information other than indicating time/frequency of the resources within the set in the coordination information.

In a second scheme, the inter-UE coordination information 706 from UE-A 702 to UE-B 704 indicate the presence of an expected/potential and/or detected resource conflict on the resources indicated by an SCI from UE-B 704.

The UE-B 704 may utilize the inter-UE coordination information 706 in various ways.

If the inter-UE coordination information 706 includes information based on the first scheme (e.g., resources that are preferred for transmissions of the UE-B 704 and/or resources that are not preferred for transmissions of the UE-B 704), the UE-B 704 may select resource(s) to be used for its sidelink transmission resource selection, or resource re-selection, may be based on both UE-B's sensing result (if available) and the received inter-UE coordination information 706 according to a first option. In a second option, the UE-B 704 may select resource(s) to be used for its sidelink transmission resource selection, or resource re-selection, may be based on the received inter-UE coordination information 706 and not based on sensing. In a third option, the UE-B 704 may select resource(s) to be used for its sidelink transmission resource selection, or resource re-selection, may be based on the received inter-UE coordination information 706 (which may allow the UE-B to use or not use sensing in combination with the inter-UE coordination information 706)

If the inter-UE coordination information 706 includes information based on the second scheme (e.g., information indicating a resource conflict), the UE-B 704 may determine resources to be re-selected based on the received inter-UE coordination information 706. The UE-B 704 may determine whether to perform a retransmission based on the received inter-UE coordination information 706. In some aspects, the UE-B 704 may use sensing information in combination with the inter-UE coordination information 706 to determine resources to be re-selected and/or to determine whether to perform a retransmission.

In a first inter-UE coordination scheme, the coordination information that is sent from UE-A to UE-B may include the set of resources that are preferred or non-preferred for the UE-B's transmission. Down selection may be performed between the preferred resource set and the non-preferred resource set. The inter-UE coordination information may indicate a time/frequency of the resources within the set and may further include additional information.

In a second inter-UE coordination scheme, the coordination information that is sent from the UE-A to the UE-B may include the presence of expected/potential and/or detected resource conflicts on the resources indicated by SCI from the UE-B. In some aspects, down-selection may be performed between the expected/potential conflict and the detected resource conflict.

In some aspects, the UE-A that transmits the inter-UE coordination information to the UE-B may be a particular UE, such as an intended receiver of UE-B. In some aspects, any UE may transmit inter-UE coordination information. In some aspects, a UE may be configured, such as in a higher-layer configuration, to transmit inter-UE coordination information.

In some aspects, the UR-A may be triggered to transmit the inter-UE coordination information based on the occurrence of a condition. In some aspects, the condition may be reception of a request for the inter-UE coordination information. In some aspects, the condition may be different than reception of a request in Mode 2. In some aspects, the transmission of inter-UE coordination information may be enabled, disabled, or otherwise controlled through a configuration of the UE.

As an example of a condition, the UE-A may transmit the inter-UE coordination information if reserved resource(s) of other UE(s) identified by the UE-A whose RSRP measurement is larger than a configured RSRP threshold, the RSRP threshold determined by at least priority value indicated by SCI of the UE(s). As another example of a condition, the UE-A may transmit the inter-UE coordination information if the resources reserved by another UE have an RSRP measurement that is smaller than a configured RSRP threshold, the RSRP threshold being determined by at least a priority value indicated by SCI of the UE(s) and the UE-A sending the inter-UE coordination information is a destination of a transport block (TB) transmitted by the UE(s). As another example of a condition, the UE-A may transmit inter-UE coordination information indicating a non-preferred resource set if the UE-A is the intended receiver of the UE-B, and does not expect to perform sidelink reception based on a half-duplex operation.

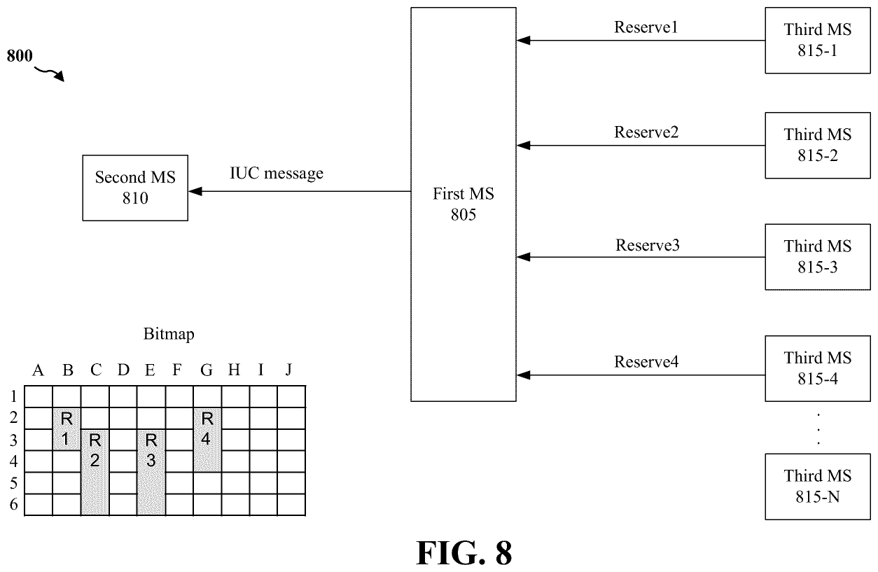

FIG. 8 is a diagram illustrating an example 800 of coordination signaling using an entry-based format or a bitmap-based format, in accordance with the present disclosure. A first mobile station (shown as “MS” in the figure), such as the first mobile station 805, may communicate with a second mobile station, such as the second mobile station 810, and one or more third mobile stations, such as the third mobile station(s) 815. The first mobile station 805, second mobile station 810, and third mobile station(s) 815 may include some or all of the features of the UE 104 described above. In some cases, the first mobile station 805 may include some or all of the features of the UE-A 702, and the second mobile station 810 may include some or all of the features of the UE-B 704, shown in FIG. 7.

In some cases, the first mobile station 805 may receive a resource reservation from one or more third mobile stations 815. For example, the third mobile station 815-1 may transmit a first resource reservation (e.g., Reserve1) for one or more resources in a resource pool. Similarly, the third mobile station 815-2 may transmit a second resource reservation (e.g., Reserve2), the third mobile station 815-3 may transmit a third resource reservation (e.g., Reserve3), and the third mobile station 815-4 may transmit a fourth resource reservation (e.g., Reserve4), for one or more resources in the resource pool, and so forth up to the third mobile station 815-N.

In some cases, reserving a resource may include configuring a resource, specifying a resource, indicating a resource, detecting a resource, identifying a resource, or determining a resource, among other examples. Thus, a resource reservation for a resource may be, or may include, a configuration of the resource, a specification of the resource, an indication of the resource, a detection of the resource, an identification of the resource, or a determination of the resource, among other examples.

In some cases, the first mobile station 805 may need to transmit an indication of the resource reservation(s) to the second mobile station 810. For example, the third mobile station(s) 815 may not be in communication with the second mobile station 810. In some cases, the third mobile station(s) 815 may be out of a communication area of the second mobile station 810, or may not be authorized to communicate with the second mobile station 810. Thus, the first mobile station 805 may transmit an inter-UE coordination (IUC) message (also referred to herein as an inter-mobile station coordination message) to the second mobile station 810 containing an indication of the resource reservation. The first mobile station 805 may transmit the IUC message to the second mobile station 810 to prevent the second mobile station 810 from attempting to reserve the one or more resources that have already been reserved by the third mobile station(s) 815. In some cases, the first mobile station 805 may receive one or more resource reservation requests from the second mobile station 810. In that case, the first mobile station 805 may transmit an IUC message to one or more of the third mobile stations 815 indicating the reserved resources.

In some cases, the first mobile station 805 may transmit the IUC message using an entry-based format. The entry-based format may individually identify the one or more resources that have been reserved, or requested to be reserved, by the third mobile station(s) 815. In some cases, each entry in the entry-based format may correspond to a resource, or a portion of a resource, that has been reserved by one of the mobile station(s) 815. For example, the entry-based format may include one or more entries for resources reserved in the Reserve1 message, one or more entries for resources reserved in the Reserve2 message, one or more entries for resources reserved in the Reserve3 message, and/or one or more entries for resources reserved in the Reserve4 message. In some cases, the total number of resources reserved by the third mobile station(s) 815 may be indicated by N. Thus, the total number of resource reservations indicated in the IUC message may be equal to N, or may be smaller than N. In some cases, the entry-based format may use a time resource indicator value (TRIV) or a frequency resource indicator value (FRIV) to identify reserved resources.

In some cases, the first mobile station 805 may transmit the IUC message using a bitmap-based format. The bitmap-based format may include a number of bits that correspond to a bitmap. For example, each bit in the bitmap, or a certain number of bits in the bitmap (e.g., each slot-subchannel), may correspond to a resource. A bit may include a first state (e.g., state 0) that indicates that the resource is not reserved, and a second state (e.g., state 1) that indicates that the resource is reserved. For example, the resource reservation Reserve1 may include the resources corresponding to B2 and B3 of the bitmap, the resource reservation Reserve2 may include the bits corresponding to C3, C4, C5, and C6 of the bitmap, the resource reservation Reserve3 may include the bits corresponding to E3, E4, E5, and E6 of the bitmap, and the resource reservation Reserve4 may include the bits corresponding to G2, G3, and C4 of the bitmap. Thus, the first mobile station 805 may transmit a “1” corresponding to bits B2, B3, C3, C4, C5, C6, E3, E4, E5, E6, G2, G3, and G4 of the bitmap, and may transmit a “0” corresponding to the remaining bits of the bitmap.

In some cases, transmissions using the bitmap-based format may reduce signaling overhead as compared to transmissions using the entry-based format. In particular, the bitmap-based format may reduce the signaling overhead when no other information is being transmitted. In some cases, the maximum number of subchannels may be 27, and the maximum time that a mobile station can reserve into the future is 32 slots. Thus, the bitmap size may be at most 864 bits (e.g., 108 bytes). In some cases, when more information (e.g., information other than the resource reservation) is needed, the size of the bitmap may increase. For example, if the mobile station were to indicate a priority value for the resource, each slot-subchannel may need at least three bits. Thus, the bitmap size may be increased to 324 bytes. In some cases, when a periodic reservation scheme is used, at least four bits may be needed for each slot-subchannel, and the bitmap size may increase to 832 bytes. In some cases, the signaling window may be increased, allowing the mobile station to reserve further into the future. For example, the mobile station may be allowed to reserve up to four thousand slots into the future, and the bitmap size may be increased to 13,900 bytes.

As described above, the mobile station may transmit the indication of the resource reservation using either an entry-based format or a bitmap-based format. In some cases, transmissions using the bitmap-based format may require lower signaling overhead than transmissions using the entry-based format. For example, the bitmap-based format may require lower signaling overhead than the entry-based format when only reservation information is being communicated. However, the bitmap-based format may not always result in low signaling overhead. For example, if other information needs to be transmitted with the resource reservation, such as priority information, or periodic reservation information, the signaling overhead of the bitmap-based format may increase. Thus, as the amount of other information being transmitted with the resource reservation increases, the benefits of the bitmap-based format (e.g., lower signaling overhead) decrease, and the benefits of the entry-based format increase. However, it may not be possible for the mobile station to determine which of the entry-based format or the bitmap-based format would result in lower signaling overhead for a particular transmission. Thus, the IUC message may use more network resources (e.g., bandwidth) and more mobile station resources (e.g., processing resources) than is necessary.

Techniques and apparatuses are described herein for inter-UE coordination using the entry-based format or the bitmap-based format. In some aspects, the mobile station may receive a resource reservation for one or more resources in a resource pool. The one or more resources in the resource pool may be configured for sidelink communications. The mobile station may transmit an indication of the resource reservation using the entry-based format or the bitmap-based format. In some aspects, the mobile station may determine (e.g., select) whether to use the entry-based format or the bitmap-based format based at least in part on a configuration of the resource pool, a periodicity of the resource reservation, a size of the resource reservation, or whether the indication of the resource reservation is multiplexed with sidelink data. The mobile station may transmit the indication of the resource reservation, using the selected entry-based format or the bitmap-based format, to a second mobile station (e.g., in an IUC message).

As described above, transmitting the indication of the resource reservation using the entry-based format may use more resources than transmitting the indication of the resource reservation using the bitmap-based format, or may use less resources than transmitting the indication of the resource reservation using the bitmap-based format, depending on certain conditions. For example, the bitmap-based format may use less resources than the entry-based format when transmitting information for the resource reservations. However, when other information (e.g., sidelink information), such as priority information, or periodic reservation information, is included with the resource reservation information, a transmission using the entry-based format may use less resources than the transmission using the bitmap-based format. Enabling the mobile station to decide which of the entry-based format, or the bitmap-based format, to use for indicating the resource reservation (e.g., in an IUC message) may reduce the number of network resources (e.g., bandwidth) and mobile station resources (e.g., processing resources) required to transmit the indication of the resource reservation.

As indicated above, FIG. 8 is provided as an example. Other examples may differ from what is described with respect to FIG. 8.

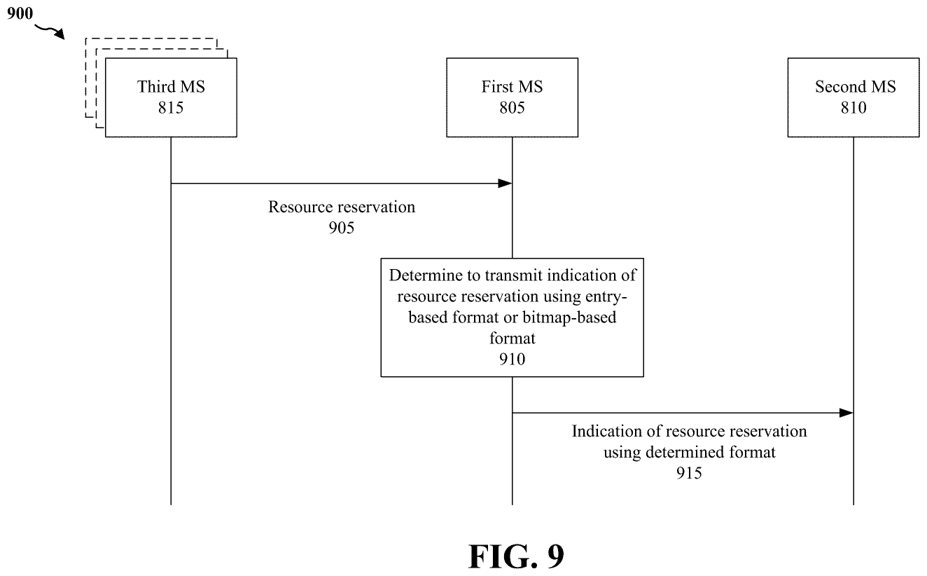

FIG. 9 is a diagram illustrating an example 900 of inter-UE coordination, in accordance with the present disclosure. A mobile station, such as the first mobile station 805, may communicate with one or more other mobile stations, such as the second mobile station 810, and the third mobile station(s) 815. As described above, the mobile stations 805, 810, and 815 may include some or all of the features of the UE 104.

As shown in connection with reference number 905, the third mobile station 815 may transmit, and the first mobile station 805 may receive, a resource reservation. The resource reservation may be a request to reserve one or more resources of a resource pool. As described above, reserving the resource may include configuring the resource, specifying the resource, indicating the resource, detecting the resource, identifying the resource, or determining the resource, among other examples. The resource pool may include a plurality of resources that may be used by the mobile stations. In some aspects, the communication from the third mobile station 815 to the first mobile station 805 may be a sidelink communication. Thus, the resource pool may include a set of time and frequency resources that are reserved to be used for sidelink communications between the third mobile station 815 and the first mobile station 805.

As shown in connection with reference number 910, the first mobile station 805 may determine whether to transmit an indication of the resource reservation using an entry-based format or a bitmap-based format. The entry-based format may use one or more entries for identifying the reserved resources. For example, the entry-based format may use a TRIV or a FRIV for identifying the reserved resources. In contrast, the bitmap-based format may use one or more bits of a bitmap for identifying the reserved resources. For example, a first state of the bit may indicate that the bit corresponds to a reserved resource, and a second state of the bit may indicate that the bit does not correspond to a reserved resource. The first mobile station 805 may determine whether to use the entry-based format or the bitmap-based format based at least in part on a configuration of the resource pool, a periodicity of the resource reservation, a size of the resource reservation, or whether the indication of the resource reservation is multiplexed with sidelink data.

In a first example, the first mobile station 805 may determine whether to transmit the indication of the resource reservation using the entry-based format or the bitmap-based format based at least in part on a configuration of the resource pool. For example, the resource pool may be configured with information that indicates whether resource reservations should be made using the entry-based format or the bitmap-based format. In some aspects, the configuration of the resource pool may be received by the first mobile station 805, for example, from the base station 102 or 180, or from another mobile station. When the first mobile station 805 receives the resource reservation, the first mobile station 805 may check the configuration of the resource pool containing the resources. The first mobile station 805 may determine to use the entry-based format if the configuration of the resource pool indicates to use the entry-based format, or the first mobile station 805 may use the bitmap-based format if the configuration of the resource pool indicates to use the bitmap-based format. Additionally, or alternatively, the first mobile station 805 may use the entry-based format if the configuration of the resource pool enables periodic reservations or may use the bitmap-based format if the configuration of the resource pool does not enable periodic reservations.

In some cases, the configuration of the resource pool may be the primary condition that determines whether to use the entry-based format or the bitmap-based format. For example, if the configuration of the resource pool indicates to use the entry-based format, or indicates to use the bitmap-based format, the first mobile station 805 may transmit the indication of the resource reservation in accordance with the configuration. In this case, the first mobile station 805 may not consider the other conditions (e.g., the periodicity of the resource reservation, a size of the resource reservation, or whether the resource reservation is multiplexed with sidelink data) if the configuration of the resource pool indicates to use the entry-based format or indicates to use the bitmap-based format.

In a second example, the first mobile station 805 may determine whether to transmit the indication of the resource reservation using the entry-based format or the bitmap-based format based at least in part on a periodicity of the resource reservation. For example, the first mobile station 805 may determine to transmit the indication of the resource reservation using the entry-based format if a periodicity of the resource reservation is greater than zero. Alternatively, the first mobile station 805 may determine to transmit the indication of the resource reservation using the entry-based format if the periodicity of the resource reservation is zero (e.g., there are no periodic transmissions using the resource).

As described above, transmitting the indication of the resource reservation using the bitmap-based format may generally require less resources than transmitting the indication of the resource reservation using the entry-based format. However, the bitmap-based format may require a greater number of resources if the resource reservations are transmitted periodically. For example, an extra bit (or multiple bits) may be needed, for each of the slot-subchannels in the bitmap, to indicate the periodicity of the resource reservations, whether or not the individual resources are using periodic transmissions. In contrast, when using the entry-based format, the first mobile station 805 may only need to indicate the periodicity for entries that require periodic transmissions. Thus, the first mobile station 805 may determine to use the entry-based format if any of the resource reservations, or a certain number of the resource reservations, require periodic transmissions.

In a third example, the first mobile station 805 may determine whether to transmit the indication of the resource reservation using the entry-based format or the bitmap-based format based at least in part on whether the indication of the resource reservation is multiplexed with sidelink data. For example, the first mobile station 805 may determine to transmit the indication of the resource reservation using the entry-based format if the indication of the resource reservation is multiplexed with sidelink data. Alternatively, the first mobile station 805 may determine to transmit the indication of the resource reservation using the bitmap-based format if the resource reservation is not multiplexed with sidelink data. The sidelink data may include priority information, RSRP information, a non-preferred level indicator (e.g., an interference indicator), or a periodicity of the resource reservation.

As described above, transmitting the indication of the resource reservation using the bitmap-based format may generally require less resources than transmitting the indication of the resource reservation using the entry-based format. However, the bitmap-based format may require a greater number of resources if number of forwarded the resource reservations is small. For example, an extra bit (or multiple bits) may be needed, for each of the slot-subchannels in the bitmap, to indicate the sidelink data, whether or not the slot-subchannels are reserved by other UEs or not. In contrast, when using the entry-based format, the first mobile station 805 may only need to indicate the sidelink data for certain entries, such as reservations by a strong interferer, or from a weak transmitter, for example. In some aspects, a permitted size of the bitmap may be fixed. Thus, if the size of the bitmap (e.g., with the sidelink data) is larger than the permitted size of the bitmap, the first mobile station 805 may determine to use the entry-based format.

In a fourth example, the first mobile station 805 may determine whether to transmit the indication of the resource reservation using the entry-based format or the bitmap-based format based at least in part on one or more signaling parameters. The first mobile station 805 may receive the one or more signaling parameters from a base station, such as the base station 102 or 180, or any of the mobile stations 810 or 815. The first mobile station 805 may determine whether to use the entry-based format or the bitmap-based format based at least in part on which format does not exceed any of the values indicated in the signaling parameters, and which format uses fewer overall resources. The first mobile station 805 may determine to transmit the indication of the resource reservation using the entry-based format if the transmission using the entry-based format does not exceed any of the values indicated in the signaling parameters, and uses fewer overall resources than a transmission using the bitmap-based format. In contrast, the first mobile station 805 may determine to transmit the indication of the resource reservation using the bitmap-based format if the transmission using the bitmap-based format does not exceed any of the values indicated in the signaling parameters, and uses fewer overall resources than a transmission using the entry-based format.

In some aspects, the signaling parameters may include parameters for determining whether to transmit the indication of the resource reservation using the entry-based format or the bitmap-based format based at least in part on whether or not the resource reservation is multiplexed with other data (e.g., sidelink data). For example, the signaling parameters may indicate, if the resource reservation is multiplexed with other data, a maximum size of the resource reservation, a maximum amount of other data that can be transmitted with the resource reservation, a maximum increase in the subchannel size, or a maximum increase in an MCS level, among other examples. Alternatively, the signaling parameters may indicate, if the resource reservation is not multiplexed with other data, a maximum size of the resource reservation, a maximum number of subchannels, and a maximum MCS level, among other examples. The maximum size of the resource reservation, the maximum number of subchannels, and the maximum MCS level, when the resource reservation is not multiplexed with other data, may be different than the maximum size of the resource reservation, the maximum number of subchannels, and the maximum MCS level, respectively, when the resource reservation is multiplexed with other data.

In some aspects, any of the conditions described in the first example, the second example, the third example, and/or the fourth example may be combined with one or more of the other conditions described in those examples. For example, the first mobile station 805 may determine whether to transmit the indication of the resource reservation using the entry-based format or the bitmap-based format based at least in part on the periodicity of the resource reservation, a size of the resource reservation, or whether the indication of the resource reservation is multiplexed with sidelink data. The first mobile station 805 may determine to use transmit the indication of the resource reservation using the entry-based format if the periodicity of the resource reservation is greater than zero, and if the resource reservation is multiplexed with other data (e.g., sidelink data). Alternatively, the first mobile station 805 may determine to use transmit the indication of the resource reservation using the bitmap-based format if the periodicity of the resource reservation is zero, and if the resource reservation is not multiplexed with other data.

In some aspects, any of the conditions described in the first example, the second example, the third example, and/or the fourth example may be combined with other conditions not described in those examples. In some aspects, the first mobile station 805 may determine an RSRP of a communication from the second mobile station 810. The first mobile station 805 may determine whether to transmit the indication of the resource reservation, using the entry-based format or the bitmap-based format, based at least in part on whether the resource reservation is multiplexed with other data, and based at least in part on whether the RSRP measurement satisfies a threshold. For example, the first mobile station 805 may determine to transmit the indication of the resource reservation using the entry-based format if the indication of the resource reservation is multiplexed with sidelink data, and if the RSRP measurement satisfies the threshold. Alternatively, the first mobile station 805 may determine to transmit the indication of the resource reservation using the bitmap-based format if the resource reservation is not multiplexed with sidelink data, and if the RSRP measurement fails to satisfy the threshold.

As shown in connection with reference number 915, the first mobile station 805 may transmit, and the second mobile station 810 may receive, the indication of the resource reservation using the determined (e.g., selected) format.

In some aspects, the first mobile station 805 may transmit the indication of the resource reservation using the entry-based format or the bitmap-based format based at least in part on the one or more conditions, such as the conditions described in the first through fourth examples in connection with reference number 910.

In the first example, the first mobile station 805 may transmit the indication of the resource reservation using the entry-based format if the configuration of the resource pool indicates to use the entry-based format. Alternatively, the first mobile station 805 may transmit the indication of the resource reservation using the bitmap-based format if the configuration of the resource pool indicates to use the bitmap-based format.

In the second example, the first mobile station 805 may transmit the indication of the resource reservation using the entry-based format if the periodicity of the resource reservation is greater than zero. Alternatively, the first mobile station 805 may transmit the indication of the resource reservation using the entry-based format if the periodicity of the resource reservation is zero.

In the third example, the first mobile station 805 may transmit the indication of the resource reservation using the entry-based format if the indication of the resource reservation is multiplexed with sidelink data. Alternatively, the first mobile station 805 may transmit the indication of the resource reservation using the bitmap-based format if the resource reservation is not multiplexed with sidelink data.

In the fourth example, the first mobile station 805 may transmit the indication of the resource reservation using the entry-based format if the transmission using the entry-based format does not exceed any of the values indicated in the signaling parameters, and uses fewer overall resources than a transmission using the bitmap-based format. In contrast, the first mobile station 805 may transmit the indication of the resource reservation using the bitmap-based format if the transmission using the bitmap-based format does not exceed any of the values indicated in the signaling parameters, and uses fewer overall resources than a transmission using the entry-based format.

As described above, the first mobile station 805 may transmit the indication of the resource reservation using the entry-based format or the bitmap-based format based at least in part on a combination of one or more of the conditions described in the first example, the second example, the third example, and the fourth example. Additionally, or alternatively, the first mobile station 805 may transmit the indication of the resource reservation using the entry-based format or the bitmap-based format based at least in part on a one or more of the conditions described in the first example, the second example, the third example, or the fourth example, and one or more other conditions, such as the RSRP measurement of the communication from the second mobile station 810.

In some aspects, the first mobile station 805 may transmit information associated with the entry-based format and information associated with the bitmap-based format. For example, the first mobile station 805 may transmit information associated with the bitmap-based format, in a coordination message, prior to transmitting the information associated with the entry-based format. The information associated with the bitmap-based format may indicate a starting point for one or more resources indicated in the entry-based format. Alternatively, the first mobile station 805 may transmit information associated with the entry-based format, in a coordination message, prior to transmitting information associated with the bitmap-based format.

In some aspects, the first mobile station 805 may identify the number of bits in the indication of the resource reservation, or may add a number of bits to the indication of the resource reservation. The second mobile station 810 may be configured with information that indicates a standard bitmap size. Thus, if the bitmap information is transmitted to the mobile station 810 before the entry information, the second mobile station 810 may be able to determine where the bitmap information ends, and where the entry information begins. However, if the entry information is transmitted before the bitmap information, the mobile station 810 may not be able to determine where the entry information ends, and where the bitmap information begins. In some aspects, the first mobile station 805 may identify the size of the entry information (e.g., in the indication of the resource reservation). Alternatively, the second mobile station 810 may be configured with a maximum size of the entry information, and if the size of the entry information is less than the maximum size of the entry information, the first mobile station 805 may add one or more bits to the entry information such that the entry information is equal to the maximum size of the entry information. Thus, the second mobile station 810 may be able to determine where the entry information ends, and the bitmap information begins.

As described above, transmitting the indication of the resource reservation using the entry-based format may use more resources than transmitting the indication of the resource reservation using the bitmap-based format, or may use less resources than transmitting the indication of the resource reservation using the bitmap-based format, depending on certain conditions. For example, the bitmap-based format may use less resources than the entry-based format when transmitting information for the resource reservations. However, when other information (e.g., sidelink information), such as priority information, or periodic reservation information, is included with the resource reservation information, a transmission using the entry-based format may use less resources than the transmission using the bitmap-based format. Enabling the mobile station to decide which of the entry-based format, or the bitmap-based format, to use for indicating the resource reservation (e.g., in an IUC message) may reduce the number of network resources (e.g., bandwidth) and mobile station resources (e.g., processing resources) required to transmit the indication of the resource reservation.

As indicated above, FIG. 9 is provided as an example. Other examples may differ from what is described with respect to FIG. 9.

The size of inter-UE coordination information messages may vary based on the type and amount of information included in the message. Aspects presented herein provide mechanisms to control the size of inter-UE coordination information, which may help to improve the gain and reliability of sidelink communication while avoiding increased overhead for the messages. In some aspects, the size of the inter-UE coordination information may be different based on whether the information is multiplexed with data or transmitted without data. In some aspects, inter-UE coordination information that is multiplexed with data may have a size that avoids increasing the MCS beyond a particular level. As an example, the inter-UE coordination information may have a size within 50 bytes so that the MCS of the data provides a good level for decoding of the data. In some aspects, the smaller size of the inter-UE coordination information that is multiplexed with data may lead to more frequent transmissions of smaller amounts of inter-UE coordination information.

Inter-UE coordination information that is transmitted without data, or separate from data, may have a more relaxed size limit. As an example, the size of the inter-UE coordination information that is transmitted separate from data may have a size of hundreds of bytes or more. The larger size may lead to less frequent transmissions than inter-UE coordination information that is multiplexed with data, yet may individual transmissions may include more information.

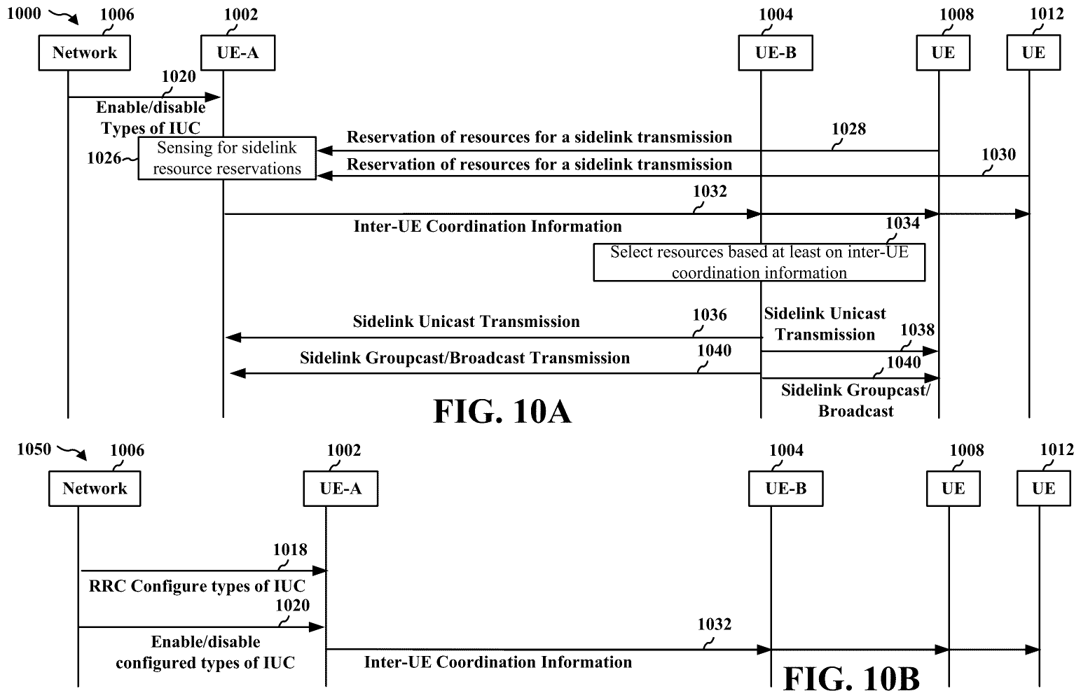

In order to control the size of inter-UE coordination information transmitted in sidelink messages, and/or to provide for particular types of inter-UE coordination information, different types of potential information may be enabled or disabled for transmission in inter-UE coordination information. FIG. 10A illustrates an example communication flow 1000 that illustrates a UE 1002 receiving signaling 1020 that indicates the one or more types of inter-UE coordination information are enabled, e.g., from a set of potential inter-UE coordination information. In some aspects, the signaling 1020 may indicate that one or more types of inter-UE coordination information that are disabled, and the UE may interpret that the non-disabled types of information are enabled. The potential types of inter-UE coordination information may include a type of resource set to be reported in the inter-UE coordination information. The potential types of inter-UE coordination information may include an identifier to identify a UE transmitting the coordination information. The potential types of inter-UE coordination information may include an identifier for a UE to which the inter-UE coordination information is transmitted, e.g., to receive the inter-UE coordination information. The potential types of inter-UE coordination information may include a resource reservation interval. The potential types of inter-UE coordination information may include a transmission priority level associated with the inter-UE coordination information. The potential types of inter-UE coordination information may include a number of sub-channels for the inter-UE coordination information. The potential types of inter-UE coordination information may include a time period associated with periodic resources, e.g., which may be referred to as a “C_resel” parameter. The C-resel parameter may indication a length of time for which a periodic resource reservation is to be applied. The periodic resource reservation may be for the UE 1002 or for a different UE, e.g., UE 1008 or 1012. The potential types of inter-UE coordination information may include a start time and/or end time of a resource selection window for the inter-UE coordination information, e.g., the window may include aspects described in connection with FIG. 6. The potential types of inter-UE coordination information may include a source ID indicated by another UE's SCI for a resource reservation. As an example, the inter-UE coordination information may indicate a source ID for the UE 1008 for resource reservation information about 1028. The potential types of inter-UE coordination information may include levels of resources. The potential types of inter-UE coordination information may include RSRP measurement information for the reserved resources. For example, the UE 1002 may include RSRP measurement information associated with 1030 when sending inter-UE coordination information about 1030. The potential types of inter-UE coordination information may include a packet priority level that is indicated by the SCI from another UE (e.g., UE 1008 or 1012) reserving resources. Each of the different types of inter-UE coordination information may include one or more bits of information to be included in the information. As the message, at 1032, may include information for multiple resources or multiple resource sets, the number of bits may be added for each resource or resource set. As an example, the overhead for transmitting a message with inter-UE coordination information may increase in scale with a number of resources reported in the message. Table 1 illustrates an example set of potential types of inter-UE coordination information that may be enabled or disabled for the UE 1002, e.g., at 1020, and an example number of bits for each of the types of information. The examples in Table 1 are merely to illustrate the concept of a set of potential types of inter-UE coordination information that may be enabled/disabled for a UE. The concept may be applied to other types of inter-UE coordination information, as well.

TABLE 1

| Option No. | Type of Inter-UE coordination information | Size |
|---|---|---|
| 1 | Type of resource set | 1 bit |
| 2 | Identifier to identify a UE transmitting/ | 12-24 bits |
| | receiving this coordination information | per |
| | | resource |
| | | set |
| 3 | Resource reservation interval | 4 bits per |
| | | resource |
| | | set |
| 4 | TX priority | 3 bits per |
| | | resource |
| | | set |
| 5 | Number of sub-channels | 3 bits per |
| | | resource |
| | | set |
| 6 | C_resel | 4 bits per |
| | | resource |
| | | set |
| 7 | Start/end time of resource selection window | 5 or 9 bits |
| | for inter-UE coordination information | |
| 8 | Source ID indicated by other UE's SCI | 12-24 bits |
| | | per |
| | | resource |
| | | set |
| 9 | Levels of resources | 1-8 bits per |
| | | resource |
| | | set |
| 10 | RSRP measurement of other UE's reserved | Varies, per |
| | resource | resource |
| | | set |
| 11 | RX priority indicated by other UE's SCI | 3 bits per |
| | | resource |
| | | set |

In some aspects, the UE 1002 may perform sensing for sidelink resource reservations, at 1026, in order to obtain or determine the inter-UE coordination information. The sensing may include aspects described in connection with any of FIG. 5A, 5B, or 6. FIG. 10A illustrates the UE 1002 receiving reservation information 1028 from UE 1008 and reservation information 1030 from the UE 1012. The reservation information 1028 and 1030 may include self-reservations from the respective UEs and/or may include inter-UE coordination information. The UE 1002 may receive sidelink reservation information from any number of UEs, e.g., one or more UEs.

FIG. 10A illustrates the UE 1002 transmitting the inter-UE coordination information 1032, which may be transmitted as a broadcast, multicast, or unicast sidelink transmission. One or more UEs may use the inter-UE coordination information to select resources for sidelink transmissions. As an example, the UE 1004 may use the inter-UE coordination information 1032 to select resources for sidelink transmission. The type of inter-UE coordination information and the use of the inter-UE coordination information may include any of the aspects described in connection with FIG. 7. The UE 1004 may then transmit a sidelink unicast transmission 1036 or 1038 or a sidelink groupcast or broadcast transmission 1040 using the resources selected at 1034.

FIG. 10B illustrates an example communication flow 1050, which may include the transmission of inter-UE coordination information 1032, as described in connection with FIG. 10A. In FIG. 10B, the UE 1002 may first receive a configuration, e.g., an RRC configuration, of a set of potential types of inter-UE coordination information that may be enabled for the UE 1002. Then, at 1020, the UE may receive an indication that enables and/or disables one or more of the previously configured types of inter-UE coordination information, e.g., configured at 1018. As an example, at 1018, the UE 1002 may receive a configuration for a set including one or more of a type of resource set, an identifier to identify a UE transmitting/receiving the inter-UE coordination information, a resource reservation interval, a number of sub-channels, a source ID indicate by the reserving UE's SCI, levels of resources, RSRP measurement of another UE's reserved resource, or a packet priority indicate by another UE's SCI. As an example, at 1020, the UE 1002 may receive control information that indicates that from the previously configured types of inter-UE coordination information, the type of resource set, the number of sub-channels, and the RSRP measurement are enabled. The UE 1002 may then transmit the inter-UE coordination information 1032 to include an indication of the resource set, the number of sub-channels, and the RSRP measurement. The message, at 1032, may include the inter-UE coordination information multiplexed with data, in some aspects. In other aspects, the message May 1032 may be transmitted without multiplexing the inter-UE coordination information with the data. In some aspects, the indication, at 1020, may indicate the enablement of a single field of the configured fields (e.g., the types of inter-UE coordination information that were configured at 1018). In some aspects, the indication, at 1020, may indicate, e.g., enable, a combination of fields from the configured fields. As an example, the indication, at 1020, may include a bit map that references a list of fields from the RRC configuration, at 1018.

Although not illustrated, the communication flow 1050 in FIG. 10B may further include any of the aspects described in connection with FIG. 10A. Although FIGS. 10A and 10B illustrate examples in which the configuration and enablement/disablement are signaled by a network device 1006 such as a base station, the configuration, at 1018, and/or the indication, at 1020, may be transmitted to the UE 1002 by an RSU, a UE, etc.

In some aspects, transmission of the inter-UE coordination may be triggered based on a condition. Table 2 illustrates various examples of conditions that may be used to trigger the transmission of inter-UE coordination. For example, Table 2 describes various conditions other than reception of an explicit request that may trigger a UE to transmit the inter-UE coordination information. As an example, in FIGS. 10A and 10B, the transmission of the inter-UE coordination information 1032 may be based on the UE 1002 detecting an occurrence of a condition. The condition may be configured for the UE 1002. Table 2 illustrates various examples of conditions that may be configured to trigger the transmission of inter-UE coordination information by a UE-A (e.g., 702, 1002, or 1102) to transmit inter-UE coordination information to a UE-B (e.g., 704, 1004, or 1104). Other conditions beyond those described in connection with Table 2 may also be configured.

TABLE 2

| Option No. | Condition |
|---|---|
| 1 | When UE-A identifies that UE-B's reserved resource(s) are |
| | overlapping with reserved resources indicated by other UE(s). |
| 2 | When the number of failure of TB decoding at UE-A side is larger |
| | than a threshold, if UE-A is a destination UE of a TB transmitted by |
| | UE-B. |
| 3 | When CBR measurement at UE-A side is larger than a threshold. |
| 4 | When priority value of reserved resource(s) of other UE(s) is smaller |
| | than a threshold. |
| 5 | When inter-UE coordination information was not transmitted for a |
| | certain duration of time. |
| 6 | UE-A's implementation/selection |
| 7 | Based on priority indicated by the received SCI |
| 8 | Inter-UE coordination information was not transmitted for a certain |
| | amount of time, e.g., pre-configured amount of time |
| 9 | Completion of a resource (re-)selection procedure, e.g. trigger for |
| | UE-A to indicate its initial-transmission resources |
| 10 | When resource selection is finished at UE-A |
| 11 | UE has sufficient sensing information to generate and provide |
| | feedback |
| 12 | UE has data for intended sidelink transmission which is multiplexed |
| | with feedback payload |
| 13 | a TX UE whose priority is higher than a threshold can be UE-A and |
| | informs its TX resources as non-preferred resources to UE-B |
| 14 | When UE-A performs transmission of a TB (e.g., UE-A having a |
| | TB to transmit) |
| 15 | When the RSRP measurement of a detected PSCCH by UE-A is |
| | larger than a threshold |
| 16 | When the distance of UE-A and other UE (detected by the zone ID |
| | indicated by other UE's SCI) is smaller than a threshold, and/or |
| | when the distance of UE-B and other UE is larger than a threshold |
| 17 | Detection that resource re-selection is to be performed by UE-B |
| 18 | When UE-A transmits a CSI request or higher-layer signaling (e.g., |
| | RRC) and expects a response |
| 19 | When UE-A identifies that UE-B's reserved resource(s) are in the |
| | same slots as its selected resources (e.g., and UE-A is an expected |
| | receiver of UE-B's transmission) |

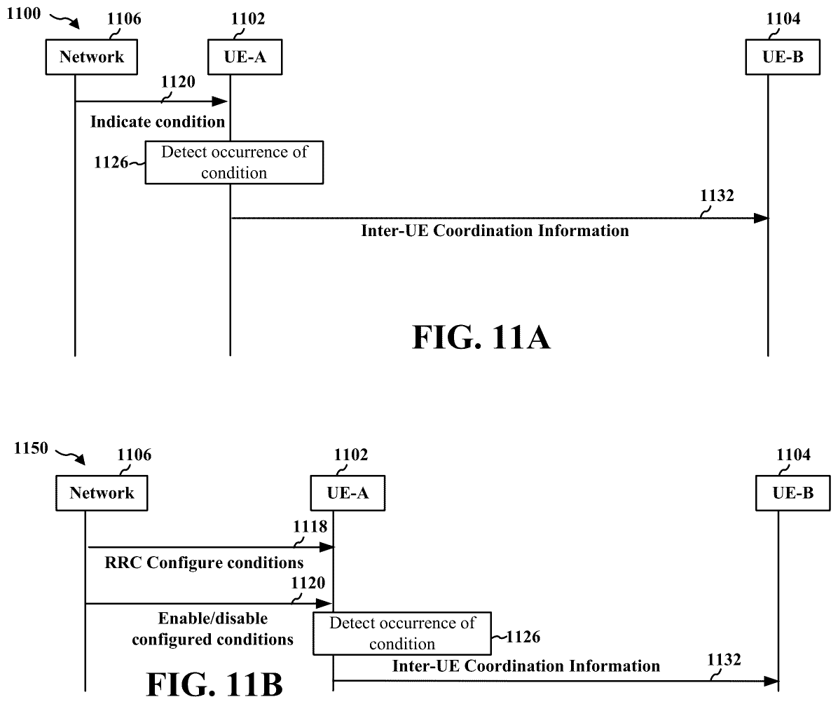

FIG. 11A illustrates an example communication flow 1100 in which a UE 1102 may receive an indication of one or more potential conditions to trigger the transmission of inter-UE coordination information. FIG. 11A illustrates a network device 1106, such as a base station, transmitting the indication 1126. In other aspects, the UE 1102 may receive the indication from an RSU, another UE, etc. The condition may include any of the example conditions described in table 2. The condition may include a different condition that the examples in table 2. The condition may be indicated from a set of potential conditions. At 1126, the UE 1102 detects an occurrence of the condition, which triggers the UE 1102 to transmit a sidelink transmission with the inter-UE coordination information 1132.

FIG. 11B illustrates an example communication flow 1150 showing that in some aspects, the UE may receive an RRC configuration of a set of condition options, at 1118. Then, the indication, at 1120, may enable or disable one or more of the configured conditions. The UE 1102 may then detect an occurrence of a condition that is enabled at 1120 from the set of potential conditions configured at 1118. The occurrence of the condition, as detected at 1126, triggers the UE 1102 to transmit the inter-UE coordination information. In some aspects, the indication, at 1120, may indicate enablement of a single condition of the configured fields. In some aspects, the indication, at 1120, may indicate, e.g., enable, a combination of conditions from the configured conditions. As an example, the indication, at 1120, may include a bit map that references a list of conditions from the RRC configuration, at 1118.

In some aspects, the amount of inter-UE coordination information may be further controlled with an additional condition. In some aspects, the UE 1102 may apply the additional condition even without the configuration and/or enablement indication. The UE 1102 may apply the additional condition in combination with the one or more conditions that are enabled, at 1120. Thus, at 1126, the UE 1102 may detect an occurrence of both the enabled condition(s) and the additional condition, which triggers the UE 1102 to transmit the inter-UE coordination information. As an example, the additional condition may include a time condition, e.g., that the inter-UE coordination information has not been transmitted for at least a threshold duration of time. In some aspects, the time condition may be applied in combination with one or more additional conditions that are selected by the UE, e.g., the condition that is enabled at 1120 may be the UE selection or UE implementation of a condition. In some aspects, the additional condition may be a congestion control condition. For example, the UE may consider the channel busy ratio (CBR) and/or the channel occupancy ratio (CR) for the UE and/or for the inter-UE coordination information before transmitting the inter-UE coordination information at 1132. For example, as a condition to transmit the inter-UE coordination information once an enabled condition has occurred, the UE 1102 may further consider whether a CBR is below a CBR threshold and/or whether a CR for the UE is below a CR threshold. If the CBR and/or CR is below the corresponding threshold, then the UE may proceed to transmit the inter-UE coordination information 1132. The CBR and/or CR threshold applied by the UE may be based on a priority level associated with the inter-UE coordination information. In some aspects, the priority value associated with the inter-UE coordination information may be defined or known by the UE. In some aspects, the priority value associated with the inter-UE coordination information may be configured for the UE, e.g., in the configuration 1118. In some aspects, the priority value for the inter-UE coordination information may be set as a highest priority value. A higher priority value will allow for a more relaxed CR (e.g., a higher CR threshold) and allow the UE to transmit the inter-UE coordination information more frequently. A lower priority value will allow for a more stringent CR (e.g., a lower CR threshold) and may lead to the UE transmitting the inter-UE coordination information less frequently.

The communication flow in FIGS. 11A and 11B may further include any of the aspects described in connection with FIGS. 10A and/or 10B.

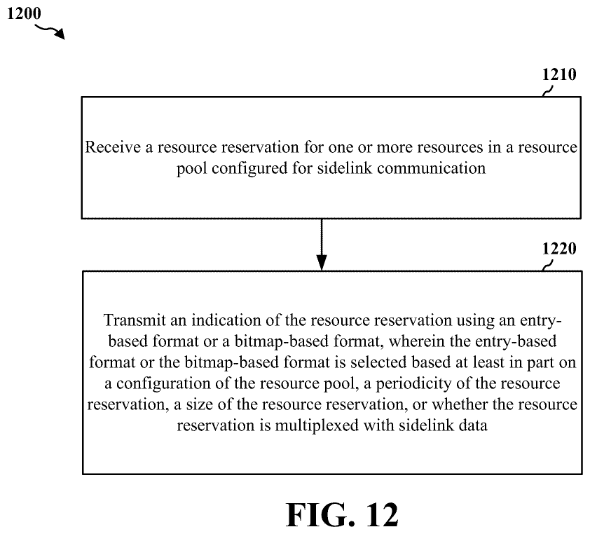

FIG. 12 is a diagram illustrating an example process 1200 performed, for example, by a UE, which may also be referred to as a mobile station, in accordance with the present disclosure. Example process 1200 is an example where the UE (e.g., mobile station 805) performs operations associated with inter-UE coordination.

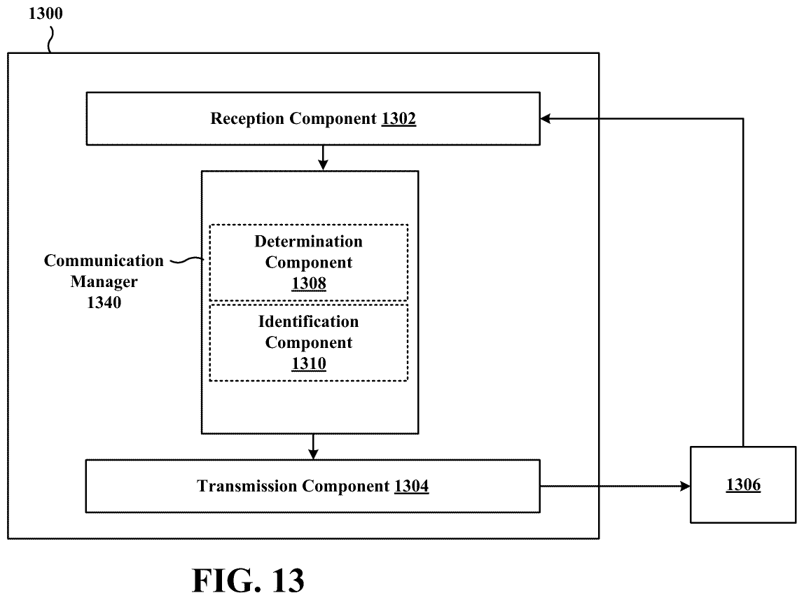

As shown in FIG. 12, in some aspects, process 1200 may include receiving a resource reservation for one or more resources in a resource pool configured for sidelink communication (block 1210). For example, the UE (e.g., using communication manager 1340 and/or reception component 1302, depicted in FIG. 13) may receive a resource reservation for one or more resources in a resource pool configured for sidelink communication, as described above.

As further shown in FIG. 12, in some aspects, process 1200 may include transmitting an indication of the resource reservation using an entry-based format or a bitmap-based format, wherein the entry-based format or the bitmap-based format is selected based at least in part on a configuration of the resource pool, a periodicity of the resource reservation, a size of the resource reservation, or whether the indication of the resource reservation is multiplexed with sidelink data (block 1220). For example, the UE (e.g., using communication manager 1340 and/or transmission component 1304, depicted in FIG. 13) may transmit an indication of the resource reservation using an entry-based format or a bitmap-based format, wherein the entry-based format or the bitmap-based format is selected based at least in part on a configuration of the resource pool, a periodicity of the resource reservation, a size of the resource reservation, or whether the indication of the resource reservation is multiplexed with sidelink data, as described above.

Process 1200 may include additional aspects, such as any single aspect or any combination of aspects described below and/or in connection with one or more other processes described elsewhere herein.

In a first aspect, the entry-based format uses a time resource indicator value or a frequency resource indicator value to identify reserved resources.

In a second aspect, alone or in combination with the first aspect, the bitmap-based format uses a plurality of bits in a bitmap to identify reserved resources.

In a third aspect, alone or in combination with one or more of the first and second aspects, a first state of a bit of the plurality of bits indicates that the bit corresponds to a reserved resource, and a second state of the bit indicates that the bit does not correspond to a reserved resource.

In a fourth aspect, alone or in combination with one or more of the first through third aspects, transmitting the indication of the resource reservation comprises receiving a configuration of the resource pool; and transmitting the indication of the resource reservation using the entry-based format based at least in part on the configuration of the resource pool indicating to use the entry-based format, or transmitting the indication of the resource reservation using the bitmap-based format based at least in part on the configuration of the resource pool indicating to use the bitmap-based format.

In a fifth aspect, alone or in combination with one or more of the first through fourth aspects, transmitting the indication of the resource reservation comprises transmitting the indication of the resource reservation using the entry-based format based at least in part on the configuration of the resource pool enabling periodic reservations, or transmitting the indication of the resource reservation using the bitmap-based format based at least in part on the configuration of the resource pool not enabling periodic reservations.

In a sixth aspect, alone or in combination with one or more of the first through fifth aspects, transmitting the indication of the resource reservation comprises transmitting the indication of the resource reservation using the entry-based format based at least in part on a periodicity of the resource reservation being greater than zero, or transmitting the indication of the resource reservation using the bitmap-based format based at least in part on the a periodicity of the resource reservation being zero.

In a seventh aspect, alone or in combination with one or more of the first through sixth aspects, transmitting the indication of the resource reservation comprises transmitting information associated with the bitmap-based format, in a coordination message, prior to transmitting information associated with the entry-based format, wherein the information associated with the bitmap-based format indicates a starting point for one or more resources indicated in the entry-based format.

In an eighth aspect, alone or in combination with one or more of the first through seventh aspects, transmitting the indication of the resource reservation comprises transmitting information associated with the entry-based format, in a coordination message, prior to transmitting information associated with the bitmap-based format.

In a ninth aspect, alone or in combination with one or more of the first through eighth aspects, process 1200 includes determining a threshold number of entries for the entry-based format, and including the number of entries in the indication of the resource reservation, or adding padded bits in the indication of the resource reservation, based at least in part on the number of entries being less than the threshold number of entries.

In a tenth aspect, alone or in combination with one or more of the first through ninth aspects, process 1200 includes determining that other information associated with the resource reservation can be sent with the indication of the resource reservation, and transmitting the other information with the indication of the resource reservation based at least in part on the determination.

In an eleventh aspect, alone or in combination with one or more of the first through tenth aspects, the other information comprises priority information, reference signal received power information, a non-preferred level indicator, or a periodicity of the resource reservation.

In a twelfth aspect, alone or in combination with one or more of the first through eleventh aspects, process 1200 includes transmitting the indication of the resource reservation using the bitmap-based format based at least in part on determining that the other information can be sent with the indication of the resource reservation.

In a thirteenth aspect, alone or in combination with one or more of the first through twelfth aspects, transmitting the indication of the resource reservation comprises transmitting the indication of the resource reservation using the entry-based format based at least in part on the indication of the resource reservation being multiplexed with sidelink data, or transmitting the indication of the resource reservation using the bitmap-based format based at least in part on the indication of the resource reservation not being multiplexed with sidelink data.

In a fourteenth aspect, alone or in combination with one or more of the first through thirteenth aspects, process 1200 includes determining that an RSRP measurement of a communication from the second UE, that includes the resource reservation, satisfies a threshold, and transmitting the indication of the resource reservation using the entry-based format based at least in part on the RSRP measurement satisfying the threshold and based at least in part on the resource reservation being multiplexed with sidelink data. The first UE may intend (e.g., be expecting) to receive the TB sent by the second UE at the resource reserved by the resource reservation.

In a fifteenth aspect, alone or in combination with one or more of the first through fourteenth aspects, process 1200 includes determining that an RSRP measurement of a communication from the second UE, that includes the resource reservation, fails to satisfy a threshold, and transmitting the indication of the resource reservation using the bitmap-based format based at least in part on the RSRP measurement failing to satisfy the threshold and based at least in part on the resource reservation not being multiplexed with sidelink data. The first UE may intend (e.g., be expecting) to receive the TB sent by the second UE at the resource reserved by the resource reservation.

In a sixteenth aspect, alone or in combination with one or more of the first through fifteenth aspects, process 1200 includes receiving one or more signaling parameters, and transmitting the indication of the resource reservation using the entry-based format or the bitmap-based format based at least in part on the one or more signaling parameters and at least one of the configuration of the resource pool, the periodicity of the resource reservation, or whether the indication of the resource reservation is multiplexed with the sidelink data.

In a seventeenth aspect, alone or in combination with one or more of the first through sixteenth aspects, the one or more signaling parameters comprise one or more entry-based parameters or one or more bitmap-based parameters.

In an eighteenth aspect, alone or in combination with one or more of the first through seventeenth aspects, the resource reservation is received by the UE from a third UE.

In a nineteenth aspect, alone or in combination with one or more of the first through eighteenth aspects, process 1200 includes transmitting, to the second UE, a second indication indicating that the indication of the resource reservation uses the entry-based format, the bitmap-based format, or both the entry-based format and the bitmap-based format.

In a twentieth aspects, alone or in combination with one or more of the first through nineteenth aspects, the second indication is included in a first stage sidelink communication, a second stage sidelink communication, or a medium access control (MAC) control element.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication. The apparatus 1300 may be a UE, which may be referred to as a mobile station, that may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 1340. The communication manager 1340 may include one or more of a determination component 1308 or an identification component 1310, among other examples.

In some aspects, the apparatus 1300 may be configured to perform one or more operations described herein in connection with FIG. 9. Additionally, or alternatively, the apparatus 1300 may be configured to perform one or more processes described herein, such as process 1200 of FIG. 12. In some aspects, the apparatus 1300 and/or one or more components shown in FIG. 13 may include one or more components of the device described in connection with FIG. 3. Additionally, or alternatively, one or more components shown in FIG. 13 may be implemented within one or more components described in connection with FIG. 3. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the device described in connection with FIG. 3.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the device described in connection with FIG. 3. In some aspects, the transmission component 1304 may be co-located with the reception component 1302 in a transceiver.

The reception component 1302 may receive a resource reservation for one or more resources in a resource pool configured for sidelink communication. The transmission component 1304 may transmit an indication of the resource reservation using an entry-based format or a bitmap-based format, wherein the entry-based format or the bitmap-based format is selected based at least in part on a configuration of the resource pool, a periodicity of the resource reservation, a size of the resource reservation, or whether the indication of the resource reservation is multiplexed with sidelink data.

The determination component 1308 may determine a threshold number of entries for the entry-based format. The identification component 1310 may include the number of entries in the indication of the resource reservation, or add padded bits in the indication of the resource reservation, based at least in part on the number of entries being less than the threshold number of entries.

The determination component 1308 may determine that other information associated with the resource reservation can be sent with the indication of the resource reservation. The transmission component 1304 may transmit the other information with the indication of the resource reservation based at least in part on the determination.

The transmission component 1304 may transmit the indication of the resource reservation using the bitmap-based format based at least in part on determining that the other information can be sent with the indication of the resource reservation.

The determination component 1308 may determine that an RSRP measurement of a communication from the second UE, that includes the resource reservation, satisfies a threshold. The transmission component 1304 may transmit the indication of the resource reservation using the entry-based format based at least in part on the RSRP measurement satisfying the threshold and based at least in part on the resource reservation being multiplexed with sidelink data. The first UE may intend (e.g., be expecting) to receive the TB sent by the second UE at the resource reserved by the resource reservation.

The determination component 1308 may determine that an RSRP measurement of a communication from the second UE, that includes the resource reservation, fails to satisfy a threshold. The transmission component 1304 may transmit the indication of the resource reservation using the bitmap-based format based at least in part on the RSRP measurement failing to satisfy the threshold and based at least in part on the resource reservation not being multiplexed with sidelink data. The first UE may intend (e.g., be expecting) to receive the TB sent by the second UE at the resource reserved by the resource reservation.

The reception component 1302 may receive one or more signaling parameters. The transmission component 1304 may transmit the indication of the resource reservation using the entry-based format or the bitmap-based format based at least in part on the one or more signaling parameters and at least one of the configuration of the resource pool, the periodicity of the resource reservation, a size of the resource reservation, or whether the indication of the resource reservation is multiplexed with the sidelink data.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

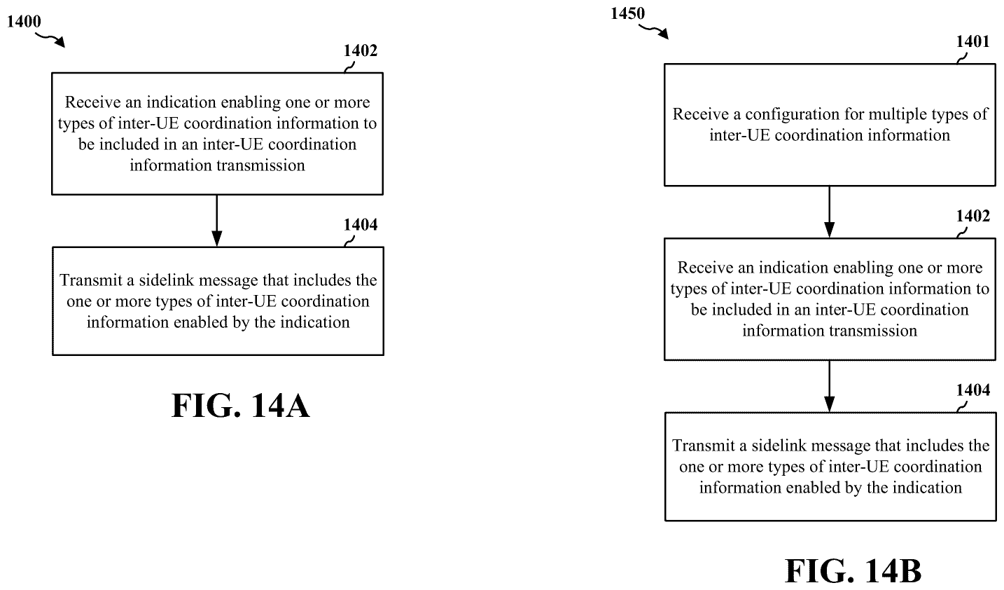

FIG. 14A is a flowchart 1400 of a method of wireless communication including the transmission of inter-UE coordination information over sidelink. The method may be performed by a UE, an RSU, or another device communicating based on sidelink (e.g., the UE 104, the device 350, the UE 402, 702, 1002, 1102; the apparatus 1602). The method may enable greater control on the size of inter-UE coordination information and may help to achieve gain in sidelink communication through inter-UE coordination information may avoiding interference and overhead due to an increased size of the inter-UE coordination information.

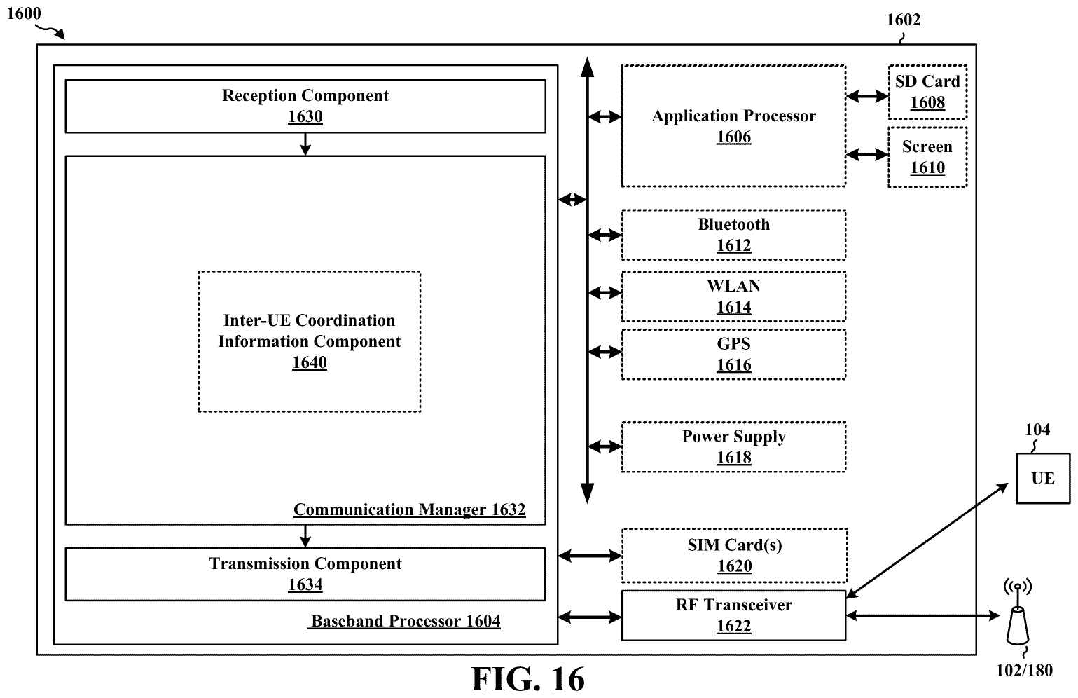

At 1402, the UE receives an indication enabling one or more types of inter-UE coordination information to be included in an inter-UE coordination information transmission. The reception may be performed, e.g., by the reception component 1630 and/or the inter-UE coordination information component 1640 of the apparatus 1602 in FIG. 16. FIGS. 10A and 10B illustrate example aspects of a UE receiving an indication enabling one or more types of inter-UE coordination information. The one or more types of inter-UE coordination information may include at least one of: a resource set type, a receiving UE identifier, a transmitting UE identifier, a resource reservation interval, a transmission priority level, a number of sub-channels, a length of time associated with a periodic resource, a resource selection window time, a source identifier of a reserving UE, a resource level, a RSRP associated with a reserved resource, or a packet priority indicated in SCI (e.g., SCI-1) from the reserving UE. The indication may be received in at least one of DCI, SCI, a MAC-CE, or RRC signaling.

At 1404, the UE transmits a sidelink message that includes the one or more types of inter-UE coordination information enabled by the indication. The UE may skip transmission of non-enabled types of inter-UE coordination information. The transmission may be performed, e.g., by the transmission component 1634 and/or the inter-UE coordination information component 1640 of the apparatus 1602 in FIG. 16. FIGS. 7, 10A, and 10B illustrate examples of a UE transmitting inter-UE coordination information.

FIG. 14B illustrates a flowchart 1450 of a method of wireless communication that may include 1402 and 1404 from FIG. 14A. As illustrated at 1401, in some aspects, the UE may receive a configuration for multiple types of inter-UE coordination information, wherein the indication enables one or more of the multiple types of inter-UE coordination information previously configured for the UE. FIG. 10B illustrates an example of a UE receiving a configuration of potential types of inter-UE coordination information. The reception may be performed, e.g., by the reception component 1630 and/or the inter-UE coordination information component 1640 of the apparatus 1602 in FIG. 16. The multiple types of inter-UE coordination information may include at least one of: a resource set type, a receiving UE identifier, a transmitting UE identifier, a resource reservation interval, a number of sub-channels, a source identifier of a reserving UE, a resource level, an RSRP associated with a reserved resource, or a packet priority indicated in SCI from the reserving UE. In some aspects, the indication may enable a combination of types of inter-UE coordination information. In some aspects, the indication may include a bit map associated with the configuration.

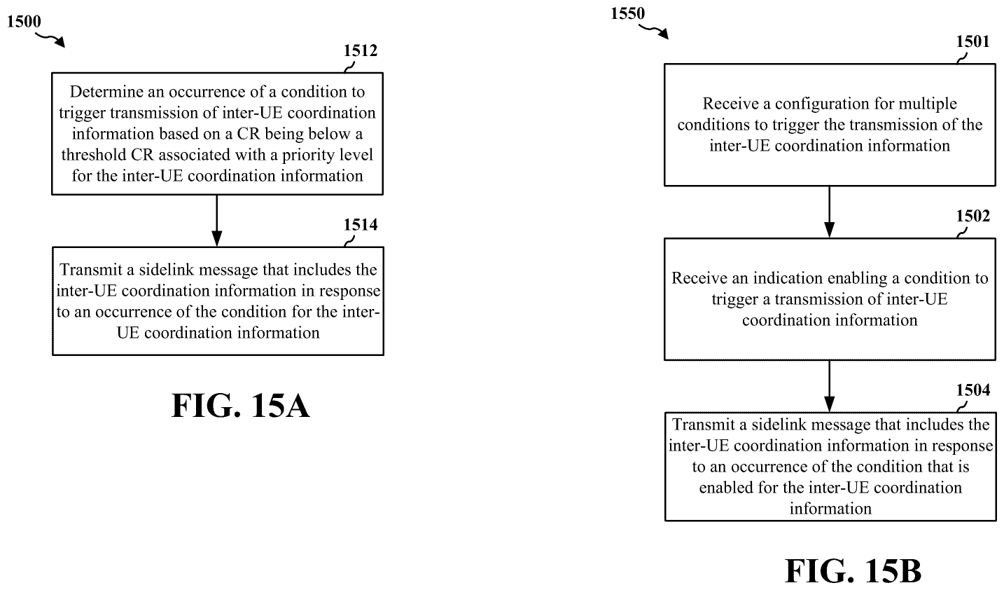

FIG. 15A is a flowchart 1500 of a method of wireless communication including the transmission of inter-UE coordination information over sidelink. The method may be performed by a UE, an RSU, or another device communicating based on sidelink (e.g., the UE 104, the device 350, the UE 402, 702, 1002, 1102; the apparatus 1602). The method may enable greater control on the congestion due to inter-UE coordination information and may help to achieve gain in sidelink communication through inter-UE coordination information may avoiding interference and overhead due to an increased amount of the inter-UE coordination information.

At 1512, the UE determines an occurrence of a condition to trigger transmission of inter-UE coordination information based on a CR being below a threshold CR associated with a priority level for the inter-UE coordination information. The condition may be different than reception of a request for the inter-UE coordination information. The priority level for the inter-UE coordination information may be configured. For example, the UE may further receive a configuration of the priority level for the inter-UE coordination information. The UE may transmit the sidelink message comprising the inter-UE coordination information further based on a duration of time from a previous inter-UE coordination information message meeting a threshold length of time. In some aspects, the condition may further include at least one of: an overlap in reserved resources between UEs, consecutive transport block decoding failures exceeds a threshold number, a CBR that exceeds a CBR threshold, a reserved resources priority value being smaller than a threshold, a threshold duration of time from a prior inter-UE coordination information message, having a transport block to transmit, a UE selection, or a second UE reserving overlapping resources with selected resources of a device transmitting the inter-UE coordination information. The determination may be performed, e.g., by the inter-UE coordination information component 1640 of the apparatus 1602 in FIG. 16.

At 1514, the UE transmits a sidelink message that includes the inter-UE coordination information in response to the occurrence of the condition for the inter-UE coordination information. The inter-UE coordination information may include at least one of: a resource set type, a receiving UE identifier, a transmitting UE identifier, a resource reservation interval, a transmission priority level, or a number of sub-channels. The inter-UE coordination information may include an entry-based format including a time resource indicator value or a frequency resource indicator value to identify reserved resources and indicates a number of entries in the inter-UE coordination information. The transmission may be performed, e.g., by the transmission component 1634 and/or the inter-UE coordination information component 1640 of the apparatus 1602 in FIG. 16.

In some aspects, the UE may receive an indication enabling the condition to trigger the transmission of the inter-UE coordination information. In some aspects, the UE may receive a configuration for multiple conditions to trigger the transmission of the inter-UE coordination information, wherein the indication enables the condition from the multiple conditions in the configuration.

In some aspects, the UE may receive an indication enabling one or more types of the inter-UE coordination information to be included in an inter-UE coordination information transmission, wherein the sidelink message includes the one or more types of the inter-UE coordination information enabled by the indication.

In some aspects, the UE may skip transmission of non-enabled types of the inter-UE coordination information. In some aspects, the inter-UE coordination information may include an indication of a resource reservation using an entry-based format or a bitmap-based format, wherein the entry-based format or the bitmap-based format is selected based at least in part on a configuration of a resource pool, a periodicity of the resource reservation, a size of the resource reservation, or whether the indication of the resource reservation is multiplexed with sidelink data.

The method may further include any of the aspects described in connection with the flowcharts in FIGS. 12, 14A, 14B, and/or 15B, and/or any of the aspects performed by the first mobile station in FIG. 9 and/or the UE-A in any of FIG. 10A, 10B, 11A, or 11B.

FIG. 15B is a flowchart 1550 of a method of wireless communication including the transmission of inter-UE coordination information over sidelink. The method may be performed by a UE, an RSU, or another device communicating based on sidelink (e.g., the UE 104, the device 350, the UE 402, 702, 1002, 1102; the apparatus 1602). The method may enable greater control on the congestion due to inter-UE coordination information and may help to achieve gain in sidelink communication through inter-UE coordination information may avoiding interference and overhead due to an increased amount of the inter-UE coordination information.

At 1502, the UE receives an indication enabling a condition to a trigger transmission of inter-UE coordination information. The reception may be performed, e.g., by the reception component 1630 and/or the inter-UE coordination information component 1640 of the apparatus 1602 in FIG. 16. FIGS. 11A and 11B illustrate example aspects of a UE receiving an indication enabling one or more conditions for transmitting inter-UE coordination information. In some aspects, the condition may include at least one of: an overlap in reserved resources between UEs, consecutive transport block decoding failures exceeds a threshold number, a CBR that exceeds a CBR threshold, a reserved resources priority value being smaller than a threshold, a threshold duration of time from a prior inter-UE coordination information message, a UE selection, or a second UE (e.g., UE-B) reserving overlapping resources with selected resources of a device transmitting the inter-UE coordination information (e.g., UE-A).

At 1504, the UE transmits a sidelink message that includes the inter-UE coordination information in response to an occurrence of the condition, e.g., the trigger, that is enabled for the inter-UE coordination information. The transmission may be performed, e.g., by the transmission component 1634 and/or the inter-UE coordination information component 1640 of the apparatus 1602 in FIG. 16. FIGS. 11A and 11B illustrate example aspects of a UE transmitting inter-UE coordination information based on one or more conditions.

As illustrated at 1501, in some aspects, the UE may receive a configuration for multiple conditions to trigger the transmission of the inter-UE coordination information, wherein the indication enables the trigger from the multiple triggers in the configuration. The reception may be performed, e.g., by the reception component 1630 and/or the inter-UE coordination information component 1640 of the apparatus 1602 in FIG. 16. FIG. 11B illustrates an example of a UE receiving a configuration of potential conditions for transmitting inter-UE coordination information.

The transmission of the sidelink message that includes the inter-UE coordination information may be further based on a duration of time from a previous inter-UE coordination information message meeting a threshold length of time. In some aspects, a priority level may be associated with the inter-UE coordination information, and a transmission of the sidelink message comprising the inter-UE coordination information is further based on a CR being below a threshold CR associated with the priority level.

FIG. 16 is a diagram 1600 illustrating an example of a hardware implementation for an apparatus 1602. The apparatus 1602 may be a UE, a component of a UE, or may implement UE functionality. The apparatus 1602 may be an RSU, a component and an RSU, or may implement RSU functionality. The apparatus may be another device configured to transmit and/or receive sidelink communication. The apparatus 1602 includes a baseband processor 1604 (also referred to as a modem) coupled to a RF transceiver 1622. In some aspects, the baseband processor 1604 may be a cellular baseband processor and/or the RF transceiver 1622 may be a cellular RF transceiver. The apparatus 1602 may further include one or more subscriber identity modules (SIM) cards 1620, an application processor 1606 coupled to a secure digital (SD) card 1608 and a screen 1610, a Bluetooth module 1612, a wireless local area network (WLAN) module 1614, a Global Positioning System (GPS) module 1616, and/or a power supply 1618. The baseband processor 1604 communicates through the RF transceiver 1622 with the UE 104 and/or BS 102/180. The baseband processor 1604 may include a computer-readable medium/memory. The computer-readable medium/memory may be non-transitory. The baseband processor 1604 is responsible for general processing, including the execution of software stored on the computer-readable medium/memory. The software, when executed by the baseband processor 1604, causes the baseband processor 1604 to perform the various functions described in the present application. The computer-readable medium/memory may also be used for storing data that is manipulated by the baseband processor 1604 when executing software. The baseband processor 1604 further includes a reception component 1630, a communication manager 1632, and a transmission component 1634. The communication manager 1632 includes the one or more illustrated components. The components within the communication manager 1632 may be stored in the computer-readable medium/memory and/or configured as hardware within the baseband processor 1604. The baseband processor 1604 may be a component of the device 350 and may include the memory 360 and/or at least one of the TX processor 368, the RX processor 356, and the controller/processor 359. In one configuration, the apparatus 1602 may be a modem chip and include just the baseband processor 1604, and in another configuration, the apparatus 1602 may be the entire UE (e.g., see 350 of FIG. 3) and include the additional modules of the apparatus 1602.

The communication manager 1632 includes an inter-UE coordination information component 1640 that is configured to determine an occurrence of a condition to trigger transmission of inter-UE coordination information based on a CR being below a threshold CR associated with a priority level for the inter-UE coordination information and transmit a sidelink message that includes the inter-UE coordination information in response to the occurrence of the condition for the inter-UE coordination information. The inter-UE coordination information component 1640 may be further configured to perform each of the blocks of the algorithm in the flowcharts of FIGS. 12, 14B, 15A, 15B, and/or the aspects performed by any of the UEs 702, 1002, or 1102, and/or any of the aspects performed by the first mobile station in FIG. 9.

The apparatus may include additional components that perform each of the blocks of the algorithm in the flowcharts of FIGS. 14A, 14B, 15A, 15B, and/or the aspects performed by any of the UEs 702, 1002, or 1102. As such, each block in the flowcharts of FIGS. 14A, 14B, 15A, 15B, and/or the aspects performed by any of the UEs 702, 1002, or 1102 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1602, and in particular the baseband processor 1604, may include means for determining an occurrence of a condition to trigger transmission of inter-UE coordination information based on a CR being below a threshold CR associated with a priority level for the inter-UE coordination information and means for transmitting a sidelink message that includes the inter-UE coordination information in response to the occurrence of the condition for the inter-UE coordination information. The apparatus may further include means for receiving an indication enabling one or more types of inter-UE coordination information to be included in inter-UE coordination information; and means for transmitting a sidelink message that includes the one or more types of inter-UE coordination information enabled by the indication. The apparatus 1602 may further include means for skipping transmission of non-enabled types of inter-UE coordination information. The apparatus 1602 may further include means for receiving a configuration for multiple types of inter-UE coordination information, wherein the indication enables one or more of the multiple types of inter-UE coordination information previously configured for the UE. The apparatus 1602 may further include means for receiving an indication enabling a trigger for inter-UE coordination information; and means for transmitting a sidelink message that includes the inter-UE coordination information in response to an occurrence of the trigger that is enabled for the inter-UE coordination information. The apparatus 1602 may further include means for receiving a configuration for multiple triggers for the inter-UE coordination information, wherein the indication enables the trigger from the multiple triggers in the configuration. The apparatus may further include means configured to perform the algorithm in the flowcharts of any of FIGS. 12, 14B, 15A, 15B, and/or the aspects performed by any of the UEs 702, 1002, or 1102, and/or any of the aspects performed by the first mobile station in FIG. 9. The means may be one or more of the components of the apparatus 1602 configured to perform the functions recited by the means. As described herein, the apparatus 1602 may include the TX Processor 368, the RX Processor 356, and the controller/processor 359. As such, in one configuration, the means may be the TX Processor 368, the RX Processor 356, and the controller/processor 359 configured to perform the functions recited by the means.

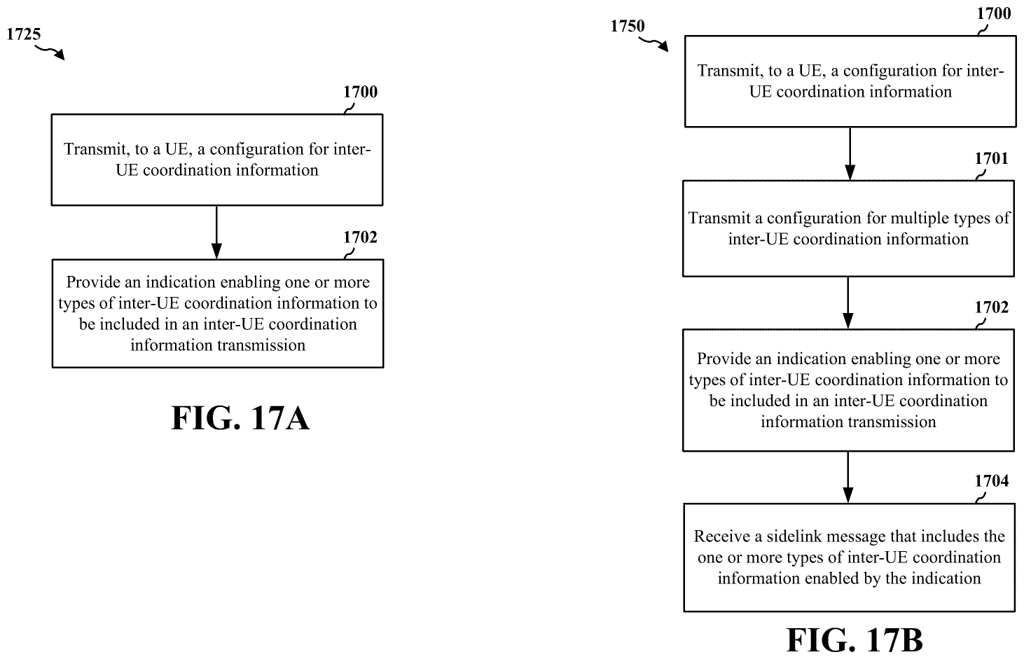

FIG. 17A is a flowchart 1725 of a method of wireless communication. The method may be performed by a network device, a base station, an RSU, or a UE (e.g., the base station 102 or 180, the RSU 107, the UE 104, the device 350, the network device 1006, 1106; the apparatus 1902). The method may enable greater control on the size of inter-UE coordination information and may help to achieve gain in sidelink communication through inter-UE coordination information may avoiding interference and overhead due to an increased size of the inter-UE coordination information.

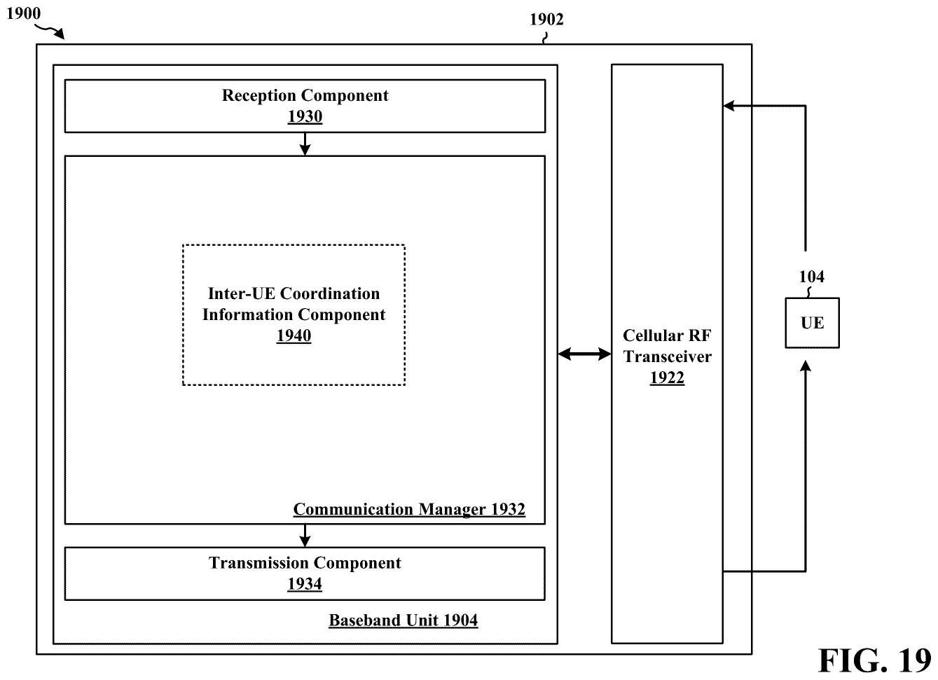

At 1700, the device transmits, to a UE, a configuration for inter-UE coordination information. In some aspects, the device may be a base station. In some aspects, the device may be an RSU. In some aspects, the device may be another UE, such as the UE to receive the inter-UE coordination information. The transmission of the configuration may be performed, e.g., by the transmission component 1934 and/or the inter-UE coordination information component 1940 of the apparatus 1902 in FIG. 19.

At 1702, the device provides an indication enabling one or more types of inter-UE coordination information to be included in an inter-UE coordination information transmission. The provision of the indication may be performed, e.g., by the transmission component 1934 and/or the inter-UE coordination information component 1940 of the apparatus 1902 in FIG. 19. FIGS. 10A and 10B illustrate example aspects of transmission of an indication enabling one or more types of inter-UE coordination information. The one or more types of inter-UE coordination information may include at least one of: a resource set type, a receiving UE identifier, a transmitting UE identifier, a resource reservation interval, a transmission priority level, a number of sub-channels, a length of time associated with a periodic resource, a resource selection window time, a source identifier of a reserving UE, a resource level, a RSRP associated with a reserved resource, or a packet priority indicated in SCI from the reserving UE. The indication may be transmitted in at least one of DCI, SCI, a MAC-CE, or RRC signaling.

FIG. 17B illustrates a flowchart 1750 of a method of wireless communication that may include 1700 and 1702 from FIG. 17A. As illustrated at 1704, in some aspects the device may receive a sidelink message that includes the one or more types of inter-UE coordination information enabled by the indication. The reception may be performed, e.g., by the reception component 1930 and/or the inter-UE coordination information component 1940 of the apparatus 1902 in FIG. 19. FIGS. 7, 10A, and 10B illustrate examples of reception of inter-UE coordination information.

As illustrated at 1701, in some aspects, the device may transmit a configuration for multiple types of inter-UE coordination information, wherein the indication enables one or more of the multiple types of inter-UE coordination information previously configured for the UE. FIG. 10B illustrates an example of transmission of a configuration of potential types of inter-UE coordination information. The transmission may be performed, e.g., by the transmission component 1934 and/or the inter-UE coordination information component 1940 of the apparatus 1902 in FIG. 19. The multiple types of inter-UE coordination information may include at least one of: a resource set type, a receiving UE identifier, a transmitting UE identifier, a resource reservation interval, a number of sub-channels, a source identifier of a reserving UE, a resource level, an RSRP associated with a reserved resource, or a packet priority indicated in SCI from the reserving UE. In some aspects, the indication may enable a combination of types of inter-UE coordination information. In some aspects, the indication may include a bit map associated with the configuration.

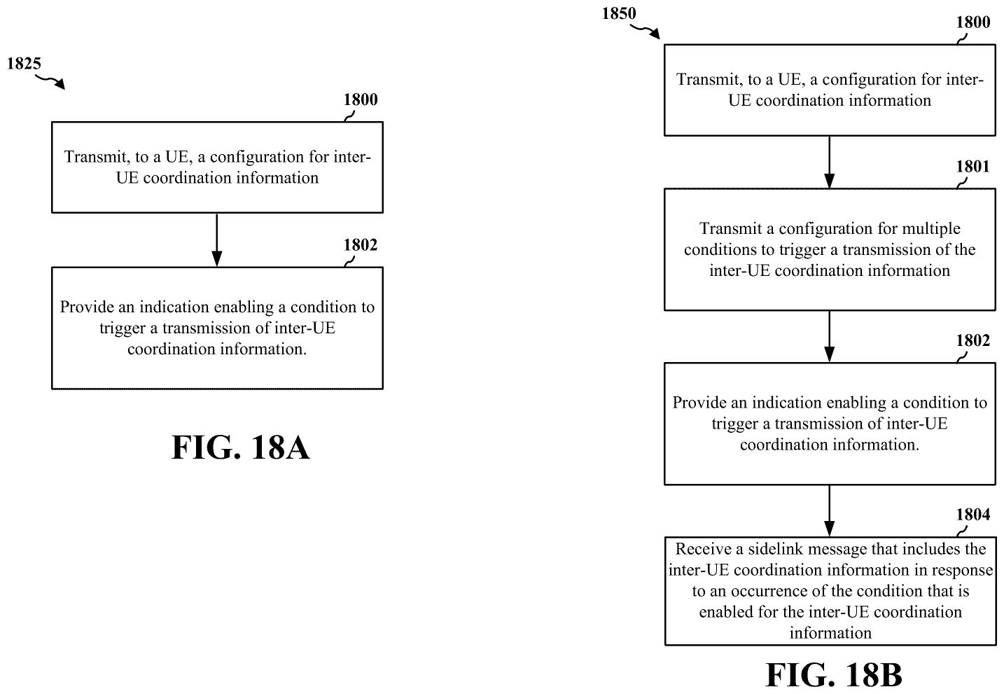

FIG. 18A is a flowchart 1825 of a method of wireless communication. The method may be performed by a network device, a base station, an RSU, or a UE (e.g., the base station 102 or 180, the RSU 107, the UE 104, the device 350, the network device 1006, 1106; the apparatus 1902). The method may enable greater control of congestion due to inter-UE coordination information and may help to achieve gain in sidelink communication through inter-UE coordination information may avoiding interference and overhead due to an increased amount of the inter-UE coordination information.

At 1800, the device transmits, to a UE, a configuration for inter-UE coordination information. In some aspects, the device may be a base station. In some aspects, the device may be an RSU. In some aspects, the device may be another UE, such as the UE to receive the inter-UE coordination information. The transmission of the configuration may be performed, e.g., by the transmission component 1934 and/or the inter-UE coordination information component 1940 of the apparatus 1902 in FIG. 19.

At 1802, the device provides an indication enabling a condition to trigger a transmission of inter-UE coordination information. The provision of the indication may be performed, e.g., by the transmission component 1934 and/or the inter-UE coordination information component 1940 of the apparatus 1902 in FIG. 19. FIGS. 11A and 11B illustrate example aspects of transmission of an indication enabling one or more conditions for transmitting inter-UE coordination information. In some aspects, the condition may include at least one of: an overlap in reserved resources between UEs, a consecutive transport block decoding failures exceeds a threshold number, a CBR that exceeds a CBR threshold, a reserved resources priority value being smaller than a threshold, a threshold duration of time from a prior inter-UE coordination information message, a UE selection, or a second UE (e.g., UE-B) reserving overlapping resources with selected resources of a device transmitting the inter-UE coordination information (e.g., UE-A).

FIG. 18B illustrates a flowchart 1850 of a method of wireless communication that may include 1800 and 1802 from FIG. 18A. As illustrated at 1804, the device may receive a sidelink message that includes the inter-UE coordination information in response to an occurrence of the condition, e.g., the trigger, that is enabled for the inter-UE coordination information. The reception may be performed, e.g., by the reception component 1930 and/or the inter-UE coordination information component 1940 of the apparatus 1902 in FIG. 19. FIGS. 11A and 11B illustrate example aspects of inter-UE coordination information based on one or more conditions.

As illustrated at 1801, in some aspects, the device may transmit a configuration for multiple conditions to trigger the transmission of the inter-UE coordination information, wherein the indication enables the trigger from the multiple conditions in the configuration. The transmission may be performed, e.g., by the transmission component 1934 and/or the inter-UE coordination information component 1940 of the apparatus 1902 in FIG. 19. FIG. 11B illustrates an example of a transmission of a configuration of potential conditions for transmitting inter-UE coordination information.

The sidelink message that includes the inter-UE coordination information may be further based on a duration of time from a previous inter-UE coordination information message meeting a threshold length of time. In some aspects, a priority level may be associated with the inter-UE coordination information, and a transmission of the sidelink message comprising the inter-UE coordination information is further based on a CR being below a threshold CR associated with the priority level.

FIG. 19 is a diagram 1900 illustrating an example of a hardware implementation for an apparatus 1902. In some aspects, the apparatus 1902 may be a base station, a component of a base station, or may implement base station functionality. In some aspects, the apparatus 1902 may be an RSU, a component of an RSU, or may implement RSU functionality. In some aspects, the apparatus 1902 may be a UE, a component of a UE, or may implement UE functionality. In some aspects, the apparatus 1902 may include a baseband unit 1904. The baseband unit 1904 may communicate through a RF transceiver 1922 with the UE 104. The baseband unit 1904 may include a computer-readable medium/memory. The baseband unit 1904 is responsible for general processing, including the execution of software stored on the computer-readable medium/memory. The software, when executed by the baseband unit 1904, causes the baseband unit 1904 to perform the various functions described supra. The computer-readable medium/memory may also be used for storing data that is manipulated by the baseband unit 1904 when executing software. The baseband unit 1904 further includes a reception component 1930, a communication manager 1932, and a transmission component 1934. The communication manager 1932 includes the one or more illustrated components. The components within the communication manager 1932 may be stored in the computer-readable medium/memory and/or configured as hardware within the baseband unit 1904. The baseband unit 1904 may be a component of the device 310 and may include the memory 376 and/or at least one of the TX processor 316, the RX processor 370, and the controller/processor 375.

The communication manager 1932 includes an inter-UE coordination information component 1940 that is configured to implement each of the blocks of the algorithm in the flowcharts of FIGS. 17A, 17B, 18A, 18B, and/or the aspects performed by the network device in FIG. 10A, 10B, 11A, or 11B.

The apparatus may include additional components that perform each of the blocks of the algorithm in the flowcharts of FIGS. 17A, 17B, 18A, 18B, and/or the aspects performed by the network device in FIG. 10A, 10B, 11A, or 11B. As such, each block in the flowcharts of FIGS. 17A, 17B, 18A, 18B, and/or the aspects performed by the network device in FIG. 10A, 10B, 11A, or 11B may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1902 may include a variety of components configured for various functions. In one configuration, the apparatus 1902, and in particular the baseband unit 1904, may include means for transmitting, to a UE, a configuration for inter-UE coordination information. The apparatus 1902 may include means for providing an indication enabling one or more types of inter-UE coordination information to be included in inter-UE coordination information. The apparatus may further include means for receiving, from the UE, a sidelink message that includes the one or more types of inter-UE coordination information enabled for the UE. The apparatus 1902 may further include means for transmitting, to the UE, a configuration for multiple types of inter-UE coordination information, wherein the indication enables one or more of the multiple types of inter-UE coordination information previously configured for the UE. The apparatus 1902 may further include means for transmitting, to a UE, an indication enabling a trigger for inter-UE coordination information. The apparatus may include means for receiving, from the UE, a sidelink message that includes the inter-UE coordination information in response to an occurrence of the trigger that is enabled for the inter-UE coordination information. The apparatus 1902 may further include means for transmitting, to the UE, a configuration for multiple triggers for the inter-UE coordination information, wherein the indication enables the trigger from the multiple triggers previously configured for the UE. The means may be one or more of the components of the apparatus 1902 configured to perform the functions recited by the means. As described supra, the apparatus 1902 may include the TX Processor 316, the RX Processor 370, and the controller/processor 375. As such, in one configuration, the means may be the TX Processor 316, the RX Processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following examples are illustrative only and may be combined with aspects of other embodiments or teachings described herein, without limitation.
Example 1 is a method of wireless communication, comprising: receiving an indication enabling one or more types of inter-UE coordination information to be included in an inter-UE coordination information transmission; and transmitting a sidelink message that includes the one or more types of the inter-UE coordination information enabled by the indication.
In aspect 2, the method of aspect 1 further includes skipping transmission of non-enabled types of the inter-UE coordination information.
In aspect 3, the method of aspect 1 or aspect further includes that the one or more types of the inter-UE coordination information include at least one of: a resource set type, a receiving UE identifier, a transmitting UE identifier, a resource reservation interval, a transmission priority level, a number of sub-channels, a length of time associated with a periodic resource, a resource selection window time, a source identifier of a reserving UE, a resource level, a RSRP associated with a reserved resource, or a packet priority indicated in SCI from the reserving UE.
In aspect 4, the method of any of aspects 1-3 further includes that the indication is received in at least one of DCI, SCI, a MAC-CE, or RRC signaling.
In aspects 5, the method of any of aspects 1-4 further includes receiving a configuration for multiple types of the inter-UE coordination information, wherein the indication enables one or more of the multiple types of the inter-UE coordination information that were previously configured.
In aspect 6, the method of aspect 5 further includes that the multiple types of the inter-UE coordination information include at least one of: a resource set type, a receiving UE identifier, a transmitting UE identifier, a resource reservation interval, a number of sub-channels, a source identifier of a reserving UE, a resource level, a RSRP associated with a reserved resource, or a packet priority indicated in SCI from the reserving UE.
In aspect 7, the method of aspect 5 or aspect 7 further includes that the indication enables a combination of types of the inter-UE coordination information.
In aspect 8, the method of any of aspects 5-7 further includes that the indication includes a bit map associated with the configuration.
Aspect 9 is an apparatus for wireless communication including at least one processor coupled to a memory, the at least one processor configured to, based at least in part on information stored in the memory, perform the method of any of aspects 1-8.
In aspect 10, the apparatus of aspect 9 further includes at least one transceiver coupled to the at least one processor.
In aspect 11, the apparatus of aspect 9 or aspect 10 further includes at least one antenna coupled to the at least one processor.
Aspect 12 is an apparatus for wireless communication including means for performing the method of any of aspects 1-8.
In aspect 13, the apparatus of aspect 12 further includes at least one transceiver.
In aspect 14, the apparatus of aspect 12 or aspect 13 further includes at least one antenna.
Aspect 15 is a non-transitory computer-readable medium storing computer executable code, where the code when executed by a processor causes the processor to implement any of aspects 1-8.
Aspect 16 is a method of wireless communication, comprising: receiving an indication enabling a condition to trigger transmission of inter-UE coordination information; and transmitting a sidelink message that includes the inter-UE coordination information in response to an occurrence of the condition that is enabled for the inter-UE coordination information.
In aspect 17, the method of aspect 16 further includes receiving a configuration for multiple conditions to trigger the transmission of the inter-UE coordination information, wherein the indication enables the condition from the multiple conditions in the configuration.
In aspect 18, the method of any of aspects 16-17 further includes that the transmitting of the sidelink message comprising the inter-UE coordination information is further based on a duration of time from a previous inter-UE coordination information message meeting a threshold length of time.
In aspect 19, the method of any of aspects 16-18 further includes that a priority level is associated with the inter-UE coordination information, and the transmitting of the sidelink message comprising the inter-UE coordination information is further based on a CR being below a threshold CR associated with the priority level.
In aspect 20, the method of any of aspects 16-19 further includes that the condition includes at least one of: an overlap in reserved resources between UEs, consecutive transport block decoding failures exceeds a threshold number, a CBR that exceeds a CBR threshold, a reserved resources priority value being smaller than a threshold, a threshold duration of time from a prior inter-UE coordination information message, having a transport block to transmit, a UE selection, or a second UE reserving overlapping resources with selected resources of a device transmitting the inter-UE coordination information.
Aspect 21 is an apparatus for wireless communication including at least one processor coupled to a memory, the at least one processor configured to, based at least in part on information stored in the memory, perform the method of any of aspects 16-20.
In aspect 22, the apparatus of aspect 21 further includes at least one transceiver coupled to the at least one processor.
In aspect 23, the apparatus of aspect 21 or aspect 22 further includes at least one antenna coupled to the at least one processor.
Aspect 24 is an apparatus for wireless communication including means for performing the method of any of aspects 16-20.
In aspect 25, the apparatus of aspect 23 further includes at least one transceiver.
In aspect 26, the apparatus of aspect 23 or aspect 24 further includes at least one antenna
Aspect 27 is a non-transitory computer-readable medium storing computer executable code, where the code when executed by a processor causes the processor to implement any of aspects 16-20.
Aspect 28 is a method of wireless communication, comprising: transmitting, to a UE, a configuration for inter-UE coordination information; and providing an indication to the UE enabling one or more types of the inter-UE coordination information to be included in an inter-UE coordination information transmission.
In aspect 29, the method of aspect 28 further includes receiving, from the UE, a sidelink message that includes the one or more types of the inter-UE coordination information enabled for the UE.
In aspect 30, the method of aspect 28 or 29 further includes that the one or more types of the inter-UE coordination information include at least one of: a resource set type, a receiving UE identifier, a transmitting UE identifier, a resource reservation interval, a transmission priority level, a number of sub-channels, a length of time associated with a periodic resource, a resource selection window time, a source identifier of a reserving UE, a resource level, a RSRP associated with a reserved resource, or a packet priority indicated in SCI from the reserving UE.
In aspect 31, the method of any of aspects 28-30 further includes that the indication is transmitted in at least one of DCI, SCI, a MAC-CE, or RRC signaling.
In aspect 32, the method of any of aspects 28-30 further includes configuring, for the UE, multiple types of the inter-UE coordination information, wherein the indication enables one or more of the multiple types of the inter-UE coordination information that were previously configured.
In aspect 33, the method of aspect 32 further includes that the multiple types of the inter-UE coordination information include at least one of: a resource set type, a receiving UE identifier, a transmitting UE identifier, a resource reservation interval, a number of sub-channels, a source identifier of a reserving UE, a resource level, a RSRP associated with a reserved resource, or a packet priority indicated in SCI from the reserving UE.
In aspect 34, the method of aspect 32 or 33 further includes that the indication enables a combination of types of the inter-UE coordination information.
In aspect 35, the method of any of aspects 32-34 further includes that the indication includes a bit map associated with the configuration.
Aspect 36 is an apparatus for wireless communication including at least one processor coupled to a memory, the at least one processor configured to, based at least in part on information stored in the memory, perform the method of any of aspects 28-35.
In aspect 37, the apparatus of aspect 36 further includes at least one transceiver coupled to the at least one processor.
In aspect 38, the apparatus of aspect 36 or aspect 37 further includes at least one antenna coupled to the at least one processor.
Aspect 39 is an apparatus for wireless communication including means for performing the method of any of aspects 28-35.
In aspect 40, the apparatus of aspect 39 further includes at least one transceiver.
In aspect 41, the apparatus of aspect 39 or aspect 40 further includes at least one antenna.
Aspect 42 is a non-transitory computer-readable medium storing computer executable code, where the code when executed by a processor causes the processor to implement any of aspects 28-35.
Aspect 43 is a method of wireless communication, comprising: transmitting, to a UE, a configuration for inter-UE coordination information; and providing an indication enabling a condition to trigger transmission of the inter-UE coordination information.
In aspect 44, the method of aspect 43 further includes receiving, from the UE, a sidelink message that includes the inter-UE coordination information in response to an occurrence of the condition that is enabled for the inter-UE coordination information.
In aspect 45, the method of aspect 43 or 44 further includes configuring, for the UE, multiple conditions to trigger the transmission of the inter-UE coordination information, wherein the indication enables the condition from the multiple conditions previously configured for the UE.
In aspect 46, the method of any of aspects 43-45 further includes that the condition includes at least one of: an overlap in reserved resources between UEs, consecutive transport block decoding failures exceeds a threshold number, a channel busy ratio (CBR) that exceeds a CBR threshold, a reserved resource priority value being smaller than a threshold, a threshold duration of time from a prior inter-UE coordination information message, a UE selection, having a transport block to transmit, or a second UE reserving overlapping resources with selected resources of a device to transmit the inter-UE coordination information.
Aspect 47 is an apparatus for wireless communication including at least one processor coupled to a memory, the at least one processor configured to, based at least in part on information stored in the memory, perform the method of any of aspects 43-46.
In aspect 48, the apparatus of aspect 47 further includes at least one transceiver coupled to the at least one processor.
In aspect 49, the apparatus of aspect 47 or aspect 48 further includes at least one antenna coupled to the at least one processor.
Aspect 50 is an apparatus for wireless communication including means for performing the method of any of aspects 43-46.
In aspect 51, the apparatus of aspect 50 further includes at least one transceiver.
In aspect 52, the apparatus of aspect 50 or aspect 51 further includes at least one antenna.
Aspect 53 is a non-transitory computer-readable medium storing computer executable code, where the code when executed by a processor causes the processor to implement any of aspects 43-46.
Aspect 54 is a method of wireless communication performed by a UE, comprising: receiving, by the UE, a resource reservation for one or more resources in a resource pool configured for sidelink communication; and transmitting, by the UE to a second UE, an indication of the resource reservation using an entry-based format or a bitmap-based format, wherein the entry-based format or the bitmap-based format is selected based at least in part on a configuration of the resource pool, a periodicity of the resource reservation, a size of the resource reservation, or whether the indication of the resource reservation is multiplexed with sidelink data.
In aspect 55, the method of aspect 1 further includes that the entry-based format uses a time resource indicator value or a frequency resource indicator value to identify reserved resources.
In aspect 56, the method of any of aspects 54-55 further includes that the bitmap-based format uses a plurality of bits in a bitmap to identify reserved resources.
In aspect 57, the method of aspect 56 further includes that a first state of a bit of the plurality of bits indicates that the bit corresponds to a reserved resource, and a second state of the bit indicates that the bit does not correspond to a reserved resource.
In aspect 58, the method of any of aspects 54-57, further comprises: receiving a configuration of the resource pool; and transmitting the indication of the resource reservation using the entry-based format based at least in part on the configuration of the resource pool indicating to use the entry-based format; or transmitting the indication of the resource reservation using the bitmap-based format based at least in part on the configuration of the resource pool indicating to use the bitmap-based format.
In aspect 59, the method of any of aspects 54-58, further comprises: receiving a configuration of the resource pool; and transmitting the indication of the resource reservation using the entry-based format based at least in part on the configuration of the resource pool enabling periodic reservations; or transmitting the indication of the resource reservation using the bitmap-based format based at least in part on the configuration of the resource pool not enabling periodic reservations.
In aspect 60, the method of any of aspects 54-59, further includes that transmitting the indication of the resource reservation comprises: transmitting the indication of the resource reservation using the entry-based format based at least in part on a periodicity of the resource reservation being greater than zero; or transmitting the indication of the resource reservation using the bitmap-based format based at least in part on the periodicity of the resource reservation being zero.
In aspect 61, the method of any of aspects 54-60 further includes that transmitting the indication of the resource reservation comprises transmitting information associated with the bitmap-based format, in a coordination message, prior to transmitting information associated with the entry-based format, wherein the information associated with the bitmap-based format indicates a starting point for one or more resources indicated in the entry-based format.
In aspect 62, the method of any of aspects 54-61 further includes that transmitting the indication of the resource reservation comprises transmitting information associated with the entry-based format, in a coordination message, prior to transmitting information associated with the bitmap-based format.
In aspect 63, the method of any of aspects 54-62, further comprises: determining a threshold number of entries for the entry-based format; and including the number of entries in the indication of the resource reservation, or adding padded bits in the indication of the resource reservation, based at least in part on the number of entries being less than the threshold number of entries.
In aspect 64, the method of any of aspects 54-63, further comprises: determining that other information associated with the resource reservation can be sent with the indication of the resource reservation; and transmitting the other information with the indication of the resource reservation based at least in part on the determination.
In aspect 65, the method of aspect 64 further includes that the other information comprises priority information, reference signal received power information, a non-preferred level indicator, or a periodicity of the resource reservation.
In aspect 66, the method of aspect 64, further comprises transmitting the indication of the resource reservation using the bitmap-based format based at least in part on determining that the other information can be sent with the indication of the resource reservation.
In aspect 67, the method of any of aspects 54-66 further includes that transmitting the indication of the resource reservation comprises: transmitting the indication of the resource reservation using the entry-based format based at least in part on the indication of the resource reservation being multiplexed with sidelink data; or transmitting the indication of the resource reservation using the bitmap-based format based at least in part on the indication of the resource reservation not being multiplexed with sidelink data.
In aspect 68, the method of any of aspects 54-67, further comprises: determining that a RSRP measurement of a communication from the second UE, that includes the resource reservation, satisfies a threshold; and transmitting the indication of the resource reservation using the entry-based format based at least in part on the RSRP measurement satisfying the threshold and based at least in part on the resource reservation being multiplexed with sidelink data.
In aspect 69, the method of any of aspects 54-68, further comprises: determining that a RSRP measurement of a communication from the second UE, that includes the resource reservation, fails to satisfy a threshold; and transmitting the indication of the resource reservation using the bitmap-based format based at least in part on the RSRP measurement failing to satisfy the threshold and based at least in part on the resource reservation not being multiplexed with sidelink data.
In aspect 70, the method of any of aspects 54-69, further comprises: receiving one or more signaling parameters; and transmitting the indication of the resource reservation using the entry-based format or the bitmap-based format based at least in part on the one or more signaling parameters and at least one of the configuration of the resource pool, the periodicity of the resource reservation, a size of the resource reservation, or whether the indication of the resource reservation is multiplexed with the sidelink data.
In aspect 71, the method of aspect 70 further includes that the one or more signaling parameters comprise one or more entry-based parameters or one or more bitmap-based parameters.
In aspect 72, the method of any of aspects 54-71 further includes that the resource reservation is received by the mobile station from a third mobile station.
In aspect 73, the method of any of aspects 54-72 further includes that the indication of the resource reservation is a coordination message.
In aspect 74, the method of any of aspects 54-73, further comprises transmitting, to the second mobile station, a second indication indicating that the indication of the resource reservation uses the entry-based format, the bitmap-based format, or both the entry-based format and the bitmap-based format.
In aspect 75, the method of any of aspects 54-74 further includes that the second indication is included in a first stage sidelink communication, a second stage sidelink communication, or a MAC-CE.
Aspect 76 is an apparatus for wireless communication at a device, comprising a processor; memory coupled with the processor; and instructions stored in the memory and executable by the processor to cause the apparatus to perform the method of one or more of aspects 54-75.
Aspect 77 is a device for wireless communication, comprising a memory and one or more processors coupled to the memory, the one or more processors configured to perform the method of one or more of aspects 54-75.
Aspect 78 is an apparatus for wireless communication, comprising at least one means for performing the method of one or more of aspects 54-75.
Aspect 79 is a non-transitory computer-readable medium storing code for wireless communication, the code comprising instructions executable by a processor to perform the method of one or more of aspects 54-75.
Aspect 80 is a non-transitory computer-readable medium storing a set of instructions for wireless communication, the set of instructions comprising one or more instructions that, when executed by one or more processors of a device, cause the device to perform the method of one or more of aspects 54-75.
Aspect 81 is a method of wireless communication at a UE, comprising: determining an occurrence of a condition to trigger transmission of inter-UE coordination information based on a CR being below a threshold CR associated with a priority level for the inter-UE coordination information; and transmitting a sidelink message that includes the inter-UE coordination information in response to the occurrence of the condition for the inter-UE coordination information.
In aspect 82, the method of aspect 81 further includes that the condition is different than reception of a request for the inter-UE coordination information.
In aspect 83, the method of aspect 81 or 82 further includes that the priority level for the inter-UE coordination information is configured.
In aspect 84, the method of aspect 83 further includes receiving a configuration of the priority level for the inter-UE coordination information.
In aspect 85, the method of any of aspects 81-84 further includes that the inter-UE coordination information includes at least one of: a resource set type, a receiving UE identifier, a transmitting UE identifier, a resource reservation interval, a transmission priority level, or a number of sub-channels.
In aspect 86, the method of any of aspects 81-85 further includes that the inter-UE coordination information comprises an entry-based format including a time resource indicator value or a frequency resource indicator value to identify reserved resources and indicates a number of entries in the inter-UE coordination information.
In aspect 87, the method of any of aspects 81-86 further includes receiving an indication enabling the condition to trigger the transmission of the inter-UE coordination information.
In aspect 88, the method of any of aspect 87 further includes receiving a configuration for multiple conditions to trigger the transmission of the inter-UE coordination information, wherein the indication enables the condition from the multiple conditions in the configuration.
In aspect 89, the method of any of aspects 81-88 further includes that the UE transmits the sidelink message comprising the inter-UE coordination information further based on a duration of time from a previous inter-UE coordination information message meeting a threshold length of time.
In aspect 90, the method of any of aspects 81-89 further includes that the condition further includes at least one of: an overlap in reserved resources between UEs, consecutive transport block decoding failures exceeds a threshold number, a CBR that exceeds a CBR threshold, a reserved resources priority value being smaller than a threshold, a threshold duration of time from a prior inter-UE coordination information message, having a transport block to transmit, a UE selection, or a second UE reserving overlapping resources with selected resources of a device transmitting the inter-UE coordination information.
In aspect 91, the method of any of aspects 81-90 further includes receiving an indication enabling one or more types of the inter-UE coordination information to be included in an inter-UE coordination information transmission, wherein the sidelink message includes the one or more types of the inter-UE coordination information enabled by the indication.
In aspect 92, the method of aspect 91 further includes that skipping transmission of non-enabled types of the inter-UE coordination information.
In aspect 93, the method of any of aspects 81-92 further includes that the inter-UE coordination information includes an indication of a resource reservation using an entry-based format or a bitmap-based format, wherein the entry-based format or the bitmap-based format is selected based at least in part on a configuration of a resource pool, a periodicity of the resource reservation, a size of the resource reservation, or whether the indication of the resource reservation is multiplexed with sidelink data.
Aspect 94 is an apparatus for wireless communication including at least one processor coupled to a memory, the at least one processor configured to, based at least in part on information stored in the memory, perform the method of any of aspects 81-93.
Aspect 95 is an apparatus for wireless communication including means for performing the method of any of aspects 81-93.
In aspect 96, the apparatus of aspect 93 or 94 further includes at least one transceiver or at least one antenna.
Aspect 97 is a non-transitory computer-readable medium storing computer executable code, where the code when executed by a processor causes the processor to implement any of aspects 81-93.

What is claimed is:

1. An apparatus for wireless communication, comprising:
memory; and
at least one processor coupled to the memory and configured to, based at least in part on information stored in the memory:
determine an occurrence of a condition to trigger transmission of inter-UE coordination information based on a channel occupancy ratio (CR) being below a threshold CR associated with a priority level for the inter-UE coordination information; and
transmit a sidelink message that includes the inter-UE coordination information in response to the occurrence of the condition for the inter-UE coordination information.

2. The apparatus of claim 1, wherein the condition is different than reception of a request for the inter-UE coordination information.

3. The apparatus of claim 1, wherein the priority level for the inter-UE coordination information is configured.

4. The apparatus of claim 3, wherein the at least one processor is further configured to:
receive a configuration of the priority level for the inter-UE coordination information.

5. The apparatus of claim 1, wherein the inter-UE coordination information includes at least one of:
a resource set type,
a receiving UE identifier,
a transmitting UE identifier,
a resource reservation interval,
a transmission priority level, or
a number of sub-channels.

6. The apparatus of claim 1, wherein the inter-UE coordination information comprises an entry-based format including a time resource indicator value or a frequency resource indicator value to identify reserved resources and indicates a number of entries in the inter-UE coordination information.

7. The apparatus of claim 1, wherein the at least one processor is further configured to:
receive an indication enabling the condition to trigger the transmission of the inter-UE coordination information.

8. The apparatus of claim 7, wherein the at least one processor is further configured to:
receive a configuration for multiple conditions to trigger the transmission of the inter-UE coordination information, wherein the indication enables the condition from the multiple conditions in the configuration.

9. The apparatus of claim 1, wherein the at least one processor is configured to transmit the sidelink message comprising the inter-UE coordination information further based on a duration of time from a previous inter-UE coordination information message meeting a threshold length of time.

10. The apparatus of claim 1, wherein the condition further includes at least one of:
an overlap in reserved resources between UEs,
consecutive transport block decoding failures exceeds a threshold number,
a channel busy ratio (CBR) that exceeds a CBR threshold,
a reserved resources priority value being smaller than a threshold,
a threshold duration of time from a prior inter-UE coordination information message,
having a transport block to transmit,
a UE selection, or
a second UE reserving overlapping resources with selected resources of a device transmitting the inter-UE coordination information.

11. The apparatus of claim 1, wherein the at least one processor is further configured to:
receive an indication enabling one or more types of the inter-UE coordination information to be included in an inter-UE coordination information transmission, wherein the sidelink message includes the one or more types of the inter-UE coordination information enabled by the indication.

12. The apparatus of claim 11, wherein the at least one processor is further configured to:
skip transmission of non-enabled types of the inter-UE coordination information.

13. The apparatus of claim 1, wherein the inter-UE coordination information includes an indication of a resource reservation using an entry-based format or a bitmap-based format, wherein the entry-based format or the bitmap-based format is selected based at least in part on a configuration of a resource pool, a periodicity of the resource reservation, a size of the resource reservation, or whether the indication of the resource reservation is multiplexed with sidelink data.

14. The apparatus of claim 1, further comprising at least one of a transceiver or an antenna coupled to the at least one processor and configured to transmit the inter-UE coordination information.

15. A method of wireless communication at a user equipment (UE), comprising:
determining an occurrence of a condition to trigger transmission of inter-UE coordination information based on a channel occupancy ratio (CR) being below a threshold CR associated with a priority level for the inter-UE coordination information; and
transmitting a sidelink message that includes the inter-UE coordination information in response to the occurrence of the condition for the inter-UE coordination information.

16. The method of claim 15, wherein the condition is different than reception of a request for the inter-UE coordination information.

17. The method of claim 15, wherein the priority level for the inter-UE coordination information is configured.

18. The method of claim 17, further comprising:
receiving a configuration of the priority level for the inter-UE coordination information.

19. The method of claim 15, wherein the inter-UE coordination information includes at least one of:
a resource set type,
a receiving UE identifier,
a transmitting UE identifier,
a resource reservation interval,
a transmission priority level, or
a number of sub-channels.

20. The method of claim 15, wherein the inter-UE coordination information comprises an entry-based format including a time resource indicator value or a frequency resource indicator value to identify reserved resources and indicates a number of entries in the inter-UE coordination information.

21. The method of claim 15, further comprising:
receiving an indication enabling the condition to trigger the transmission of the inter-UE coordination information.

22. The method of claim 21, further comprising:
receiving a configuration for multiple conditions to trigger the transmission of the inter-UE coordination information, wherein the indication enables the condition from the multiple conditions in the configuration.

23. The method of claim 15, wherein the UE transmits the sidelink message comprising the inter-UE coordination information further based on a duration of time from a previous inter-UE coordination information message meeting a threshold length of time.

24. The method of claim 15, wherein the condition further includes at least one of:
an overlap in reserved resources between UEs,
consecutive transport block decoding failures exceeds a threshold number,
a channel busy ratio (CBR) that exceeds a CBR threshold,
a reserved resources priority value being smaller than a threshold,
a threshold duration of time from a prior inter-UE coordination information message,
having a transport block to transmit,
a UE selection, or
a second UE reserving overlapping resources with selected resources of a device transmitting the inter-UE coordination information.

25. The method of claim 15, further comprising:
receiving an indication enabling one or more types of the inter-UE coordination information to be included in an inter-UE coordination information transmission,
wherein the sidelink message includes the one or more types of the inter-UE coordination information enabled by the indication.

26. The method of claim 25, further comprising:
skipping transmission of non-enabled types of the inter-UE coordination information.

27. The method of claim 15, wherein the inter-UE coordination information includes an indication of a resource reservation using an entry-based format or a bitmap-based format, wherein the entry-based format or the bitmap-based format is selected based at least in part on a configuration of a resource pool, a periodicity of the resource reservation, a size of the resource reservation, or whether the indication of the resource reservation is multiplexed with sidelink data.

28. An apparatus for wireless communication, comprising:
memory; and
at least one processor coupled to the memory and configured to, based at least in part on information stored in the memory:
transmit, to a user equipment (UE), a configuration for inter-UE coordination information; and
provide an indication to the UE enabling one or more types of the inter-UE coordination information to be included in an inter-UE coordination information transmission or a condition to trigger transmission of the inter-UE coordination information.

29. The apparatus of claim 28, wherein the at least one processor is further configured to:
receive, from the UE, a sidelink message that includes the one or more types of the inter-UE coordination information enabled for the UE, wherein the one or more types of the inter-UE coordination information include at least one of:
a resource set type,
a receiving UE identifier,
a transmitting UE identifier,
a resource reservation interval,
a transmission priority level, or
a number of sub-channels.

30. The apparatus of claim 28, wherein the at least one processor is further configured to:
receive, from the UE, a sidelink message that includes the inter-UE coordination information in response to an occurrence of the condition that is enabled for the inter-UE coordination information.
